(19) United States
(12) Patent Application Publication
(10) Pub. No.: US 2017/0127166 A1
(43) Pub. Date: May 4, 2017

(54) LIGHTING DEVICE AND DISPLAY DEVICE

(71) Applicant: Sharp Kabushiki Kaisha, Osaka (JP)

(72) Inventor: Mikihiro NOMA, Osaka (JP)

(73) Assignee: Sharp Kabushiki Kaisha, Osaka (JP)

(21) Appl. No.: 15/318,616

(22) PCT Filed: Jun. 12, 2015
(86) PCT No.: PCT/JP2015/067023

§ 371 Date: Dec. 13, 2016

(30) Foreign Application Priority Data
Jun. 20, 2014 (JP) 2014-127121

(51) Int. Cl. H04R 1/04; H04R 7/16; G02F 1/1333; F21V 8/00; G02F 1/1335

(52) U.S. Cl. CPC H04R 1/04; G02B 6/0078; G02F 1/133606; G02F 1/13338; G02F 1/133308; G02B 6/0088; H04R 7/16; G02F 2001/133314; G02F 1/133608; G02F 1/133603; G02F 1/133605; G02B 6/0073; H04R 2499/15

(57) ABSTRACT

A backlight device (illumination device) includes LEDs (light sources), sheet-shaped optical members that apply optical effects to light from the LEDs, and vibrating elements that are attached to the optical members and make the optical members vibrate. The vibrating elements can be attached to a non-effective region of the optical members, for example. Here, when an effective region is defined to be a region of the optical members that applies optical effects to the light from the LEDs and then emits that light effectively, the non-effective region can be a frame-shaped region that surrounds the effective region.

### TECHNICAL FIELD

The present invention relates to an illumination device and a display device.

### BACKGROUND ART

Patent Document 1 discloses an example of a conventional liquid crystal display device. In Patent Document 1, a sound source unit is arranged in a recess in the bottom of an outer case, and a surface-emitting backlight and a liquid crystal display panel are layered in that order on top of the sound source unit and are housed within the outer case. In the sound source unit, a piezoelectric diaphragm having a layered structure in which a piezoelectric ceramic film is sandwiched between a pair of circular electrodes is housed within a protective case and fixed, via a C-shaped double-sided adhesive spacer arranged spanning a prescribed region around the protective case, to a light-reflecting sheet on the rear surface of the surface-emitting backlight such that a separation is maintained from the bottom surface of the outer case. The opening in the C-shaped double-sided adhesive spacer is connected to a sound conduction channel. The C-shaped double-sided adhesive spacer is made of a vibration damping material and therefore inhibits propagation of vibrations from the piezoelectric diaphragm to the light-reflecting sheet.

### RELATED ART DOCUMENT

### Patent Document

Patent Document 1: Japanese Patent Application Laid-Open Publication No. 2008-193486

### Problems to be Solved by the Invention

In the device disclosed in Patent Document 1, sound generated by making the piezoelectric diaphragm vibrate travels via the sound conduction channel and is then emitted from the front side of the device. However, this configuration makes it difficult to reduce the thickness of the device because the sound conduction channel must be formed in order to direct the sound generated by the vibrations of the piezoelectric diaphragm towards the front side of the device, and a separation from the outer case must be maintained in order to prevent vibrations from the piezoelectric diaphragm from propagating to the outer case.

### SUMMARY OF THE INVENTION

The present invention was made in light of the foregoing and aims to make it possible to reduce the thickness of such a device.

### Means for Solving the Problems

An illumination device according to the present invention includes: a light source; an optical member that is sheet-shaped and applies an optical effect to light from the light source; and a vibrating element attached to the optical member for causing the optical member to vibrate.

In this way, the sheet-shaped optical member applies an optical effect to the light emitted from the light source as that light exits. The vibrating element is attached to the optical members and makes the optical member vibrate. Therefore, setting the vibration frequency of the vibrating element to high values makes it possible to produce sound by using the optical member as a diaphragm, and setting the vibration frequency of the vibrating element to lower values than above makes it possible to transmit vibrations via the optical member to the user of the illumination device, for example.

This configuration is advantageous in terms of making the illumination device thinner, because unlike in conventional configurations in which sound generated by making a piezoelectric diaphragm vibrate must pass through a sound conduction channel formed in the device before being emitted from the front side, the present configuration removes the need to allocate space for a sound conduction channel inside of the illumination device and also removes the need to maintain a gap between the vibrating element and the other components.

The following configurations represent preferred embodiments of the illumination device according to the present invention.

(1) The optical member may be demarcated into an effective region where an optical effect is applied to light from the light source and the light is effectively emitted, and a non-effective region that is frame-shaped and surrounds the effective region, and the vibrating element may be attached to the non-effective region of the optical member. This configuration prevents the light to which optical effects are applied in the effective region of the optical member from being blocked or absorbed by the vibrating element. This, in turn, prevents the optical functionality of the optical member from being harmed as a result of attaching the vibrating element.

(2) The optical member may be provided in a plurality that are layered together with one another, and among the plurality of optical members, the optical member to which the vibrating element attaches may have the vibrating element attached to a surface of the optical member facing the plurality of optical members. In other words, the vibrating element can be arranged in the same arrangement space used for the optical members that are layered onto the optical member to which the vibrating element is attached, which is particularly advantageous in terms of making the illumination device thinner.

(3) The optical member may include at least a light guide plate for guiding light from the light source, and the vibrating element may be attached to the light guide plate. The light guide plate has a greater thickness and a higher rigidity than the other optical members (such as optical sheets), and therefore attaching the vibrating element to the light guide plate makes it possible to more satisfactorily transmit the vibrations from the vibrating element.

(4) The light guide plate may include a plurality of divided light guide plates, and the vibrating element may be provided in a plurality with one attaching to each of the plurality of divided light guide plates. This configuration makes it possible to selectively make the divided light guide plates vibrate by individually controlling the operation of the vibrating elements that are individually attached to the divided light guide plates. This, in turn, makes it possible to transmit sound or vibration to the user from a specific one of the divided light guide plates.

(5) The optical member may include a diffusion plate that diffuses light from the light source, whereas the light source may have a light-emitting surface for emitting light and is arranged with that light-emitting surface opposing a surface of the diffusion plate, and the vibrating element may be attached to the diffusion plate. In this configuration, the light emitted from the light-emitting surface of the light source travels towards and enters the surface of the diffusion plate that is arranged facing the light-emitting surface, and this light is diffused by the diffusion plate as it exits and travels towards a display panel. This reduces irregularities in brightness in the light that illuminates the display panel and also results in a higher light utilization efficiency than in an edge-lit backlight device. Furthermore, attaching the vibrating element to the diffusion plate makes it possible to transmit vibrations through the diffusion plate to the user of the illumination device.

(6) The vibrating element may be a film-shaped film-type vibrating element and may make surface-to-surface contact with a surface of the optical member. This makes it possible to transmit vibrations from the film-type vibration element to the entire surface of the optical member that is arranged in surface contact with the film-type vibration element.

(7) The film-type vibration element may have had a reflective treatment for making a surface thereof reflect light. In this configuration, light from the light source reflects off of the surface of the film-type vibration element, thereby making it possible to emit that light more efficiently. This reduces the number of component parts and the number of assembly steps required in comparison with a configuration that includes a reflective sheet separate from the film-type vibration element as an optical member for reflecting light and is therefore advantageous in terms of reducing production costs.

Next, in order to solve the abovementioned problems, a display device according to the present invention includes: the illumination device described above; and a display panel that is arranged on a light-emitting side of the illumination device and uses light from the illumination device to display an image.

Configuring the display device in this way makes it possible to make the illumination device thinner, thereby making it possible to make the overall display device thinner as well.

The following configurations represent preferred embodiments of the display device according to the present invention.

(1) The display device may further include an outer case housing the display panel and the illumination device, and sound conduction openings that are open to outside may be formed in the outer case. In this configuration, the sound produced by the vibrations transmitted from the vibrating element to the optical member is emitted to the external environment through the sound conduction openings formed in the outer case in order to be made audible to the user.

(2) The display device may further include a touch panel disposed on a side of the display panel opposite to the illumination device and having a touch panel pattern for detecting a position of input from a user. In this configuration, when the user inputs a position to the touch panel according to the image displayed on the display panel, the touch panel pattern detects the position of that input. Vibrations from the vibrating element can then be transmitted via the optical member to the touch panel in order to transmit those vibrations to the user when the user inputs a position on the touch panel.

(3) The display panel may be a liquid crystal panel in which a liquid crystal material is sealed between a pair of substrates. This type of display device is advantageous because it can be used for a wide variety of purposes, such as in displays for mobile computing devices (including tablet computers), television receivers, and the like, for example.

### Effects of the Invention

The present invention makes it possible to provide a thinner device.

### BRIEF DESCRIPTION OF THE DRAWINGS

FIG. 1 is a cross-sectional view illustrating the configuration of a cross section taken in a short side direction of a tablet-type mobile computing device (a liquid crystal display device) according to Embodiment 1 of the present invention.

FIG. 2 is a plan view of a liquid crystal panel for a liquid crystal display device.

FIG. 3 is a plan view of a backlight device for a liquid crystal display device.

FIG. 4 is a bottom view of a liquid crystal display device.

FIG. 5 is an exploded perspective schematically illustrating the configuration of a television receiver according to Embodiment 2 of the present invention.

FIG. 6 is an exploded perspective view schematically illustrating the configuration of a liquid crystal display device.

FIG. 7 is a cross-sectional view illustrating the configuration of a cross section taken in a short side direction of a liquid crystal display device.

FIG. 8 is a plan view of a backlight device for a liquid crystal display device.

FIG. 9 is a plan view of a backlight device according to Embodiment 3 of the present invention.

FIG. 10 is a plan view of a backlight device according to Embodiment 4 of the present invention.

FIG. 11 is a cross-sectional view illustrating the configuration of a cross section taken in a short side direction of a liquid crystal display device according to Embodiment 5 of the present invention.

FIG. 12 is a cross-sectional view illustrating the configuration of a cross section taken in a short side direction of a liquid crystal display device according to Embodiment 6 of the present invention.

FIG. 13 is an exploded perspective schematically illustrating the configuration of a liquid crystal display device according to Embodiment 7 of the present invention.

FIG. 14 is a plan view of a backlight device for a liquid crystal display device.

FIG. 15 is a cross-sectional view illustrating the configuration of a cross section taken in a short side direction of a liquid crystal display device.

FIG. 16 is a cross-sectional view illustrating the configuration of a cross section taken in a short side direction of a liquid crystal display device according to Embodiment 8 of the present invention.

FIG. 17 is a cross-sectional view illustrating the configuration of a cross section taken in a short side direction of a liquid crystal display device according to Embodiment 9 of the present invention.

FIG. 18 is a cross-sectional view illustrating the configuration of a cross section taken in a short side direction of a liquid crystal display device according to Embodiment 10 of the present invention.

### DETAILED DESCRIPTION OF EMBODIMENTS

### Embodiment 1

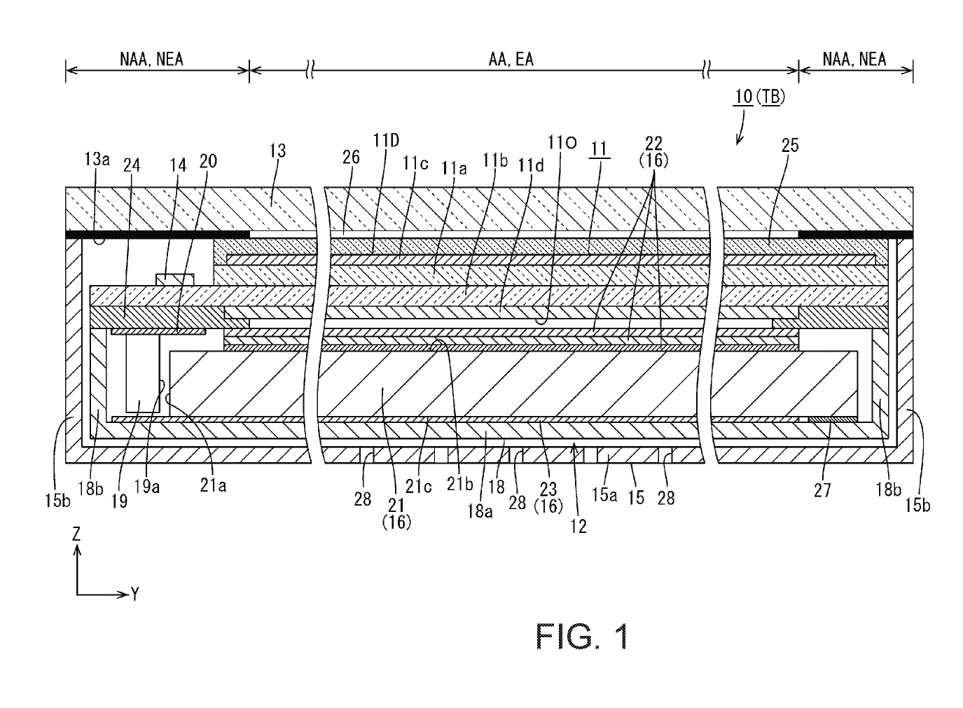

Next, Embodiment 1 of the present invention will be described with reference to FIGS. 1 to 4. In the present embodiment, a liquid crystal display device 10 for a tablet-type mobile computing device (a mobile computing device) TB will be described as an example. Note that X, Y, and Z coordinate axes are provided in each figure and point in the directions shown. Moreover, the “up” and “down” directions are defined according to FIG. 1. Based on this definition, the “front side” of a component would refer to the upper side of that component in FIG. 1, and similarly, the “rear side” of a component would refer to the lower side of that component in FIG. 1.

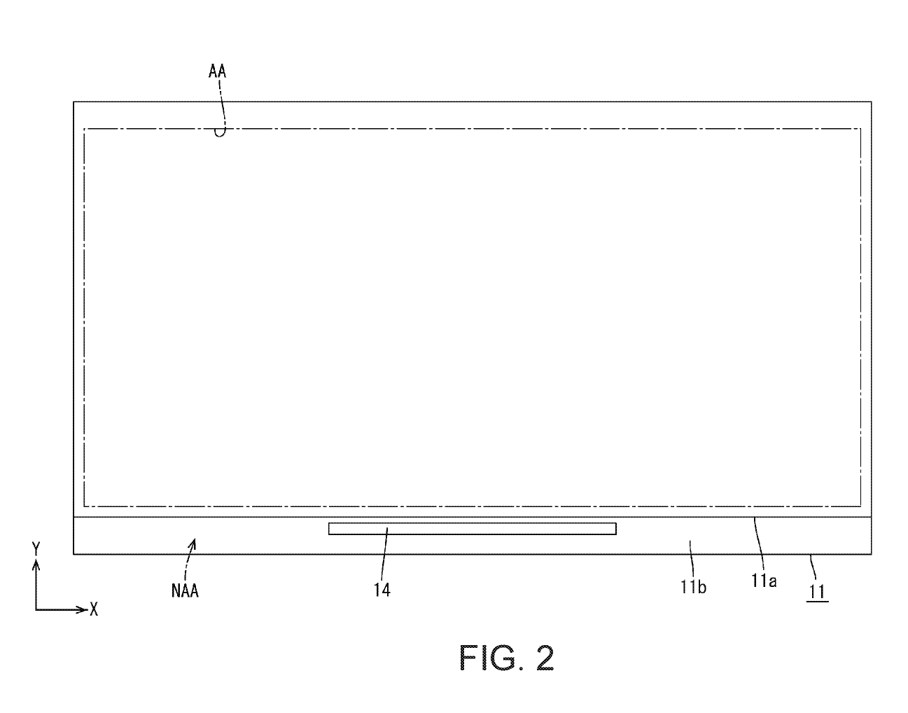

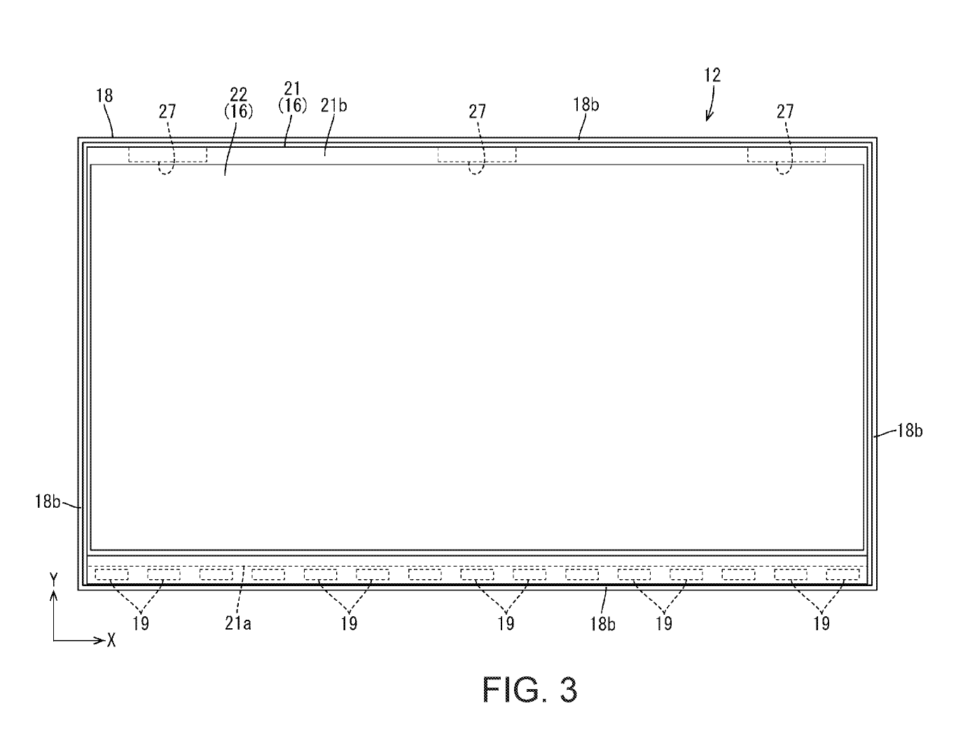

As illustrated in FIGS. 2 and 3, the tablet-type mobile computing device TB has a horizontally elongated rectangular shape overall. The tablet-type mobile computing device TB includes components such as the liquid crystal display device 10 (described later) and a data communication unit (not illustrated in the figures) for communicating with (sending and receiving data to and from) an external base station or the like. Next, the configuration of the liquid crystal display device 10 for the tablet-type mobile computing device TB will be described in detail.

As illustrated in FIG. 1, the liquid crystal display device 10 includes at least a liquid crystal panel (display unit, display panel) 11 in which the front surface is a display surface 11D that displays images and the rear surface is an opposite surface 11O; a backlight device (illumination device) 12 that is arranged on the rear side of the liquid crystal panel 11 so as to face the opposite surface 11O and illuminates the liquid crystal panel 11 with light; a cover panel (touch panel, outer plate) 13 that is arranged on the front side of the liquid crystal panel 11 so as to face the display surface 11D (that is, on the side opposite to the backlight device 12 side); and a casing (housing, outer case) 15 that houses the liquid crystal panel 11, the backlight device 12, and the cover panel 13. The screen of the liquid crystal panel 11 is of a size that would typically be classified as a small- to mid-sized screen, such as approximately 7 inches to 20 inches, for example. Next, each of the components of the liquid crystal display device 10 will be described in detail.

First, the liquid crystal panel 11 will be described. As illustrated in FIG. 2, the liquid crystal panel 11 has a horizontally elongated rectangular shape overall when viewed in a plan view. As illustrated in FIG. 1, the liquid crystal panel 11 includes a pair of substantially transparent glass substrates 11a and 11b that have excellent transparency as well as a liquid crystal layer (not illustrated in the figure) that is sandwiched between the substrates 11a and 11b and contains liquid crystal molecules having optical properties that change when an electric field is applied. The substrates 11a and 11b are sealed together, with a gap equal to the thickness of the liquid crystal layer maintained therebetween, using a sealant (not illustrated in the figure). The display surface 11D of the liquid crystal panel 11 is divided into a display region (an active area) AA in which images are displayed and a non-display region (a non-active area) NAA that has a frame shape surrounding the display region AA and in which images are not displayed. The display region AA has a rectangular shape when viewed in a plan view. The liquid crystal panel 11 can display images in the display region AA of the display surface 11D using light supplied from the backlight device 12, and the front side of the liquid crystal panel 11 is the light-emitting side. Moreover, the short side direction of the liquid crystal panel 11 is parallel to the Y axis direction, while the long side direction is parallel to the X axis direction and the thickness direction is parallel to the Z axis direction.

Of the substrates 11a and 11b of the liquid crystal panel 11, the substrate on the front side (front surface side) is a color filter (CF) substrate 11a, and the substrate on the rear side (rear surface side) is an array substrate 11b. As illustrated in FIG. 2, the length of the long sides of the array substrate 11b is substantially equal to the length of the long sides of the CF substrate 11a, while the length of the short sides of the array substrate 11b is greater than the length of the short sides of the CF substrate 11a. Furthermore, although one of the long side edges of the array substrate 11b is aligned with the corresponding edge of the CF substrate 11a, the other long side edge of the array substrate 11b protrudes out from the corresponding edge of the CF substrate 11a, and a driver (panel driver) 14 for driving the liquid crystal panel 11 and a flexible substrate (not illustrated in the figure) for supplying signals to the driver 14 are mounted on this protruding edge. In other words, the edge of the array substrate 11b that does not overlap with the CF substrate 11a when viewed in a plan view provides a mounting region for the driver 14 and the flexible substrate. The driver 14 is constituted by an LSI chip having an internal driver circuit and is mounted directly on the edge (mounting region) of the array substrate 11b using a chip-on-glass (COG) technology. The driver 14 processes signals sent from a panel control circuit via the flexible substrate, generates output signals accordingly, and can supply these output signals to TFTs in the display region AA (described later). Moreover, polarizers 11c and 11d are fixed to the outer surface sides of the substrates 11a and 11b, respectively.

Next, the internal components in the display region AA of the liquid crystal panel 11 will be described (note that none of these components are illustrated in the figures). A large number of thin-film transistors (TFTs; switching elements) and pixel electrodes are arranged in a matrix pattern (rows and columns) on the inner surface side (the liquid crystal layer side/the opposite surface side relative to the CF substrate 11a) of the array substrate 11b, and gate lines and source lines are arranged in a grid pattern surrounding the TFTs and the pixel electrodes. The driver 14 respectively supplies signals related to the images to be displayed to the gate lines and the source lines. The pixel electrodes that are arranged in the rectangular regions surrounded by the gate lines and the source lines are made of a transparent electrode material such as indium tin oxide (no) or zinc oxide (ZnO).

Meanwhile, a large number of color filters are arranged on the inner surface side of the CF substrate 11a at positions corresponding to the pixels. The color filters are constituted by red (R), green (G), and blue (B) color filters that are arranged in an alternating manner. A light shielding layer (a black matrix) is formed between the color filters in order to block mixed colors of light. A counter electrode that faces the pixel electrodes on the array substrate 11b side is formed over the surface of the color filters and the light shielding layer. The CF substrate 11a is smaller than the array substrate 11b in both dimensions. Furthermore, alignment films (not illustrated in the figures) for aligning the liquid crystal molecules contained in the liquid crystal layer are respectively formed on the inner surface sides of both of the substrates 11a and 11b.

Next, the configuration of the backlight device 12 will be described in detail. As illustrated in FIG. 3, and similar to the liquid crystal panel 11, the backlight device 12 has a substantially rectangular block shape overall when viewed in a plan view. As illustrated in FIG. 1, the backlight device 12 includes at least a substantially box-shaped chassis 18 that is open towards the liquid crystal panel 11 side, light-emitting diodes (LEDs; light sources) 19, an LED substrate (light source substrate) 20 on which the LEDs 19 are mounted, and optical members 16 that apply optical effects to the light from the LEDs 19 and then emit that light towards the liquid crystal panel 11. The optical members 16 include at least a light guide plate (optical member) 21 that guides in the light from the LEDs 19, optical sheets (optical members) 22 that are layered onto the front side of the light guide plate 21, and a reflective sheet (optical member, reflective member) 23 that is layered onto the rear side of the light guide plate 21. The backlight device 12 is a one-side edge-lit (side-lit) backlight device in which the LEDs 19 (and LED substrate 20) are arranged along just one of the long sides of the backlight device 12 and the liquid crystal panel 11 such that light only enters the light guide plate 21 from one side. Furthermore, the backlight device 12 includes panel fixing tape 24 for fixing the liquid crystal panel 11 in place. The panel fixing tape 24 is formed by applying an adhesive to both surfaces of a base material that is made of a synthetic resin and that has a rectangular frame shape overall that runs around the peripheral edges of the liquid crystal panel 11. The surface of the base material of the panel fixing tape 24 has a black color that provides light-shielding properties and prevents light that escapes from the backlight device 12 from passing through the non-display region NAA of the liquid crystal panel 11. Next, each of the components of the backlight device 12 will be described in order.

The chassis 18 is made of a metal material (such as aluminum), and as illustrated in FIG. 1, is substantially box-shaped and open towards the front side such that the LED substrate 20 and the optical members 16 can be housed inside. The chassis 18 includes a bottom portion 18a that is rectangular (similar to the liquid crystal panel 11) when viewed in a plan view and side portions 18b that respectively protrude up towards the front side from the outer edges on each side of the bottom portion 18a (that is, on both short sides and on both long sides). The short side direction of the chassis 18 (bottom portion 18a) is parallel to the Y axis direction while the long side direction is parallel to the X axis direction. The surface of the bottom portion 18a is parallel to the surface of the liquid crystal panel 11 and supports the optical members 16 (the light guide plate 21, the optical sheets 22, and the reflective sheet 23) housed inside of the chassis 18 from the rear side. The side portions 18b are arranged surrounding the optical members 16 (the light guide plate 21, the optical sheets 22, and the reflective sheet 23) housed inside of the chassis 18 from the peripheral sides thereof and thus form an elongated rectangular frame shape overall. Moreover, the end faces of the side portions 18b are fixed to the rear surface of the panel fixing tape 24.

As illustrated in FIG. 1, the LEDs 19 are formed by using a resin material to seal LED chips (LED elements; semiconductor light-emitting elements) on a substrate portion that is fixed to the surface of the LED substrate 20. The LED chips mounted on the substrate portion emit light of primarily one wavelength. More specifically, the LED chips emit a single color of blue light. Meanwhile, a phosphor that emits light of a prescribed color when excited by the blue light emitted from the LED chips is dispersed in the resin material used to seal the LED chips. Overall, the LED chip-resin material assemblies emit primarily white light. The LEDs 19 are so-called side-emitting LEDs in which the side faces that are adjacent to the mounting faces attached to the LED substrate 20 are the light-emitting surfaces 19a.

As illustrated in FIG. 1, the LED substrate 20 includes a flexible, film-shaped (sheet-shaped) substrate portion (base material) that is made of an insulating material, and the surface of the substrate portion is parallel to the surface of the liquid crystal panel 11. The LEDs 19 are surface-mounted on the rear surface of the LED substrate 20 (that is, the surface on the side opposite to the liquid crystal panel 11 side; the surface that faces the light guide plate 21 side), and a wiring pattern (not illustrated in the figure) for supplying power to the LEDs 19 is also patterned onto this surface. The LED substrate 20 has a rectangular shape that extends parallel to the long side direction of the backlight device 12 (that is, in the X axis direction), and a plurality of the LEDs 19 are mounted intermittently in a line running in that extension direction. The length of the long sides of the LED substrate 20 is the same as the length of the long sides of the light guide plate 21, while the length of the short sides of the LED substrate 20 is greater than the distance between the light guide plate 21 and the side portions 18b of the chassis 18. As a result, the portion of the LED substrate 20 on the light guide plate 21 side in the short side direction (the Y axis direction) overlaps with the front side of the light guide plate 21. The LED substrate 20 is arranged on the rear side of the liquid crystal panel 11 in the Z axis direction and is fixed to the liquid crystal panel 11 by the panel fixing tape 24.

Next, the common components of the optical members 16 will be described. As illustrated in FIGS. 1 and 3, the optical members 16 have a horizontally elongated rectangular sheet shape, and the optical members 16 are arranged overlapping substantially entirely with the liquid crystal panel 11 when viewed in a plan view. The region of the optical members 16 that overlaps with the display region AA of the liquid crystal panel 11 when viewed in a plan view (a display-overlapping region) functions as an effective region EA that applies an optical effect to light and then emits that light effectively towards the display region AA, while the frame-shaped region of the optical members 16 that overlaps with the non-display region NAA of the liquid crystal panel 11 when viewed in a plan view (a non-display-overlapping region) is a non-effective region NEA that does not substantially contribute to supplying light towards the display region AA.

The light guide plate 21 of the optical members 16 is made of a synthetic resin material (such as a polycarbonate or an acrylic resin such as polymethyl methacrylate (PMMA), for example) that has a refractive index sufficiently higher than that of air and is also substantially transparent (exhibits excellent transparency). As illustrated in FIGS. 1 and 3, the light guide plate 21 has a rectangular sheet shape that is smaller than the bottom portion 18a of the chassis 18 in both dimensions. The short side direction of the light guide plate 21 is parallel to the Y axis direction, while the long side direction is parallel to the X axis direction and the thickness direction that is orthogonal to the surface of the light guide plate 21 is parallel to the Z axis direction. The light guide plate 21 has a greater thickness than that of the other optical members 16 (the optical sheets 22 and the reflective sheet 23) and therefore has a relatively high rigidity (hardness). The light guide plate 21 is housed inside of the chassis 18 with the periphery of the light guide plate 21 surrounded by the side portions 18b and is also arranged at a position directly beneath the liquid crystal panel 11 and the optical sheets 22. Of the peripheral end faces of the light guide plate 21, the end face along the long side illustrated on the left side in FIG. 1 faces the LEDs 19 and functions as a light-receiving face (light source-facing end face) into which the light from the LEDs 19 enters. In contrast, the three peripheral end faces of the light guide plate 21 other than the light-receiving face 21a (that is, the end face along the long side illustrated on the right side in FIG. 1, and the end faces along the pair of short sides) are all non-LED-facing end faces (non-light source-facing end faces) that do not face the LEDs 19. Meanwhile, of the pair of front and rear surfaces of the light guide plate 21, the surface that faces the front side (the liquid crystal panel 11 side) functions as a light-exiting surface 21b that allows light to exit towards the liquid crystal panel 11. In contrast, the surface of the light guide plate 21 that faces the rear side is an opposite surface 21c that is on the side opposite to the light-exiting surface 21b. In this configuration, the direction in which the LEDs 19 and the light guide plate 21 are arranged is parallel to the Y axis direction while the direction in which the optical sheets 22 (and the liquid crystal panel 11) and the light guide plate 21 are arranged is parallel to the Z axis direction, and these arrangement directions are orthogonal to one another. Furthermore, the light guide plate 21 guides the light emitted in primarily the Y axis direction from the LEDs 19 away from the light-receiving face 21a, spreads that light throughout the interior of the light guide plate 21, and then directs the light towards the optical sheet 22 side (the front side, the light-exiting side) and allows the light to exit from the light-exiting surface 21b (the front surface). Moreover, a light-reflecting pattern (not illustrated in the figures) that is constituted by a light-reflecting portion and reflects the light inside of the light guide plate 21 towards the light-exiting surface 21b in order to promote emission of light from the light-exiting surface 21b is formed on the opposite surface 21c of the light guide plate 21.

As illustrated in FIGS. 1 and 3, the optical sheets 22 of the optical members 16 have a rectangular shape similar to the light guide plate 21 when viewed in a plan view. The short side direction of the optical sheets 22 is parallel to the Y axis direction, while the long side direction is parallel to the X axis direction and the thickness direction that is orthogonal to the surfaces of the optical sheets 22 is parallel to the Z axis direction. The optical sheets 22 are placed on the front side of the light-exiting surface 21b of the light guide plate 21 and are arranged between the liquid crystal panel 11 and the light guide plate 21 such that the optical sheets 22 transmit light emitted from the light guide plate 21 and also apply prescribed optical effects to that transmitted light while allowing the light to exit towards the liquid crystal panel 11. The optical sheets 22 are constituted by a plurality of sheets (three sheets in the present embodiment) that are layered together. Of these sheets, the peripheral edges of the optical sheet 22 that is arranged furthest towards the front side is fixed to the rear surface of the panel fixing tape 24. Moreover, specific examples of types of sheets for the optical sheets 22 include diffusion sheets, lens sheets, and reflective polarizing sheets, for example. The types of optical sheets used can be selected from among these examples as appropriate.

As illustrated in FIG. 1, the reflective sheet 23 of the optical members 16 is arranged on the rear side of the light guide plate 21 (that is, covering the opposite surface 21c on the side opposite to the light-exiting surface 21b). The reflective sheet 23 is constituted by a sheet made of a synthetic resin having a white surface color with excellent reflectivity and therefore makes it possible to efficiently redirect any light that propagates through the light guide plate 21 and exits from the opposite surface 21c back towards the front side (that is, towards the light-exiting surface 21b). The reflective sheet 23 has a rectangular shape similar to the light guide plate 21 and the optical sheets 22 when viewed in a plan view, and the majority of the center portion of the reflective sheet 23 is sandwiched between the light guide plate 21 and the bottom portion 18a of the chassis 18. Of the peripheral edges of the reflective sheet 23, the edge on the LED substrate 20 side extends out from the light-receiving face 21a of the light guide plate 21 to a position beyond the LEDs 19, and therefore this extended portion makes it possible to efficiently reflect light from the LEDs 19 into the light-receiving face 21a.

Next, the cover panel 13 will be described. As illustrated in FIG. 1, the cover panel 13 is arranged covering the entire liquid crystal panel 11 from the front side in order to protect the liquid crystal panel 11 and also serves as the front exterior side of the liquid crystal display device 10 and the tablet-type mobile computing device TB. The rear surface of the cover panel 13 is fixed to the display surface 11D of the liquid crystal panel 11 using an adhesive 25. The adhesive 25 is made of an ultraviolet-curing resin material, for example. The cover panel 13 is made of a substantially transparent plate-shaped glass base material with excellent translucency, and it is preferable that the cover panel 13 be made of tempered glass. It is preferable that a chemically strengthened glass that has a chemically strengthened surface layer formed by applying a chemical strengthening process to the surface of a plate-shaped glass base material, for example, be used as the tempered glass for the cover panel 13. Here, this chemical strengthening process refers to a process in which a plate-shaped glass base material is strengthened by using ion replacement to replace the alkali metal ions contained in the glass material with alkali metal ions of a larger radius such that the resulting chemically strengthened layer is a compressively stressed layer (ion replacement layer) that is left in a state of compressive stress, for example. This gives the cover panel 13 high mechanical strength and impact tolerance, thereby making it possible to reliably prevent damage to or breakage of the liquid crystal panel 11 that is arranged on the rear side of the cover panel 13.

As illustrated in FIG. 1, the cover panel 13 has a horizontally elongated rectangular shape similar to the liquid crystal panel 11 when viewed in a plan view and is larger than the liquid crystal panel 11 in both dimensions when viewed in a plan view. As a result, the peripheral portion of the cover panel 13 extends out (overhangs) over the peripheral edges of the liquid crystal panel 11. A light-shielding portion 13a that surrounds the display region AA of the liquid crystal panel 11, is arranged overlapping with the non-display region NAA when viewed in a plan view, and blocks light around the periphery of the display region AA (the region outside of the display region AA) is formed in the cover panel 13. The light-shielding portion 13a is made of a light-shielding material such as a black paint, for example, and this light-shielding material is formed integrated with the rear surface of the cover panel 13 (that is, the surface on the liquid crystal panel 11 side) by being printed onto that surface. The light-shielding portion 13a is capable of blocking visible light, infrared light, and ultraviolet light. Moreover, the light-shielding portion 13a can be formed using a printing method such as screen printing or inkjet printing, for example. The light-shielding portion 13a is formed on the portion of the cover panel 13 that overlaps with the entire non-display region NAA of the liquid crystal panel 11 as well as on the peripheral portion that extends out beyond the peripheral edges of the liquid crystal panel 11 (that is, on substantially the entire region outside of the display region AA) in order to form a substantially elongated frame shape when viewed in a plan view. This makes it possible for the light-shielding portion 13a to block any light from the backlight device 12 that escapes to the region outside of the display region AA before that light reaches the rear surface of the cover panel 13. In other words, the light-shielding portion 13a is formed over substantially the entire portion of the cover panel 13 that does not overlap with the display region AA of the liquid crystal panel 11 when viewed in a plan view.

As illustrated in FIG. 1, a touch panel pattern 26 for detecting the position of user input is formed on the rear side (that is, the liquid crystal panel 11 side) surface of the cover panel 13. In other words, the cover panel 13 functions as both as an outer case plate for the tablet-type mobile computing device TB and the liquid crystal display device 10 and as a touch panel. The touch panel pattern 26 is a so-called projected-capacitive pattern formed by arranging a large number of transparent touch panel electrodes (not illustrated in the figure) in a matrix pattern on the rear surface of the cover panel 13. A flexible substrate (not illustrated in the figure) is connected to the cover panel 13, and electric potential for detecting position is supplied via this flexible substrate to the touch panel pattern 26.

The casing 15 is made of a synthetic resin material or a metal material, and as illustrated in FIGS. 1 and 3, is substantially box-shaped and open towards the front side such that the liquid crystal panel 11 and the backlight device 12 can be housed by inserting them through the opening from the front side. The casing 15 includes a bottom portion 15a and a sidewall 15b that is substantially tube-shaped and extends up from the peripheral edges of the bottom portion 15a towards the front side, and the upper end faces of the sidewall 15b support the cover panel 13 around the entire peripheral edge thereof from the rear side. Furthermore, the substantially tube-shaped sidewall 15b surrounds components such as the liquid crystal panel 11 and the backlight device 12 from the outer peripheral side.

As illustrated in FIG. 1, in the liquid crystal display device 10 according to the present embodiment, vibrating elements 27 are attached to the optical members 16, and the vibrating elements 27 make the optical members 16 vibrate. Setting the vibration frequency of the vibrating elements 27 to a high value makes it possible to produce sound by using the optical members 16 as a diaphragm. Meanwhile, setting the vibration frequency of the vibrating elements 27 to a lower value than above makes it possible to transmit vibrations via the optical members 16 to the user of the liquid crystal display device 10. This configuration is advantageous in terms of making the backlight device 12 thinner because unlike in conventional configurations in which sound generated by making a piezoelectric diaphragm vibrate must pass through a sound conduction channel formed in the device before being emitted from the front side, the present configuration removes the need to allocate space for a sound conduction channel inside of the backlight device 12 and also removes the need to maintain a gap between the vibrating elements 27 and the other components of the backlight device 12.

The vibrating elements 27 can (reversibly) convert back and forth between vibrations (mechanical energy) and electrical signals (electrical energy). More specifically, the vibrating elements 27 are driven at a prescribed vibration frequency in accordance with electrical signals supplied from a vibrating element controller (not illustrated in the figure) that is connected via wires (not illustrated in the figure). The vibrating element controller can control the operation of the vibrating elements 27 and makes it possible to produce sound waves resulting from vibration of the optical members 16 to which the vibrating elements 27 are attached by driving the vibrating elements 27 at vibration frequencies higher than the minimum frequency that is audible to humans, for example. Meanwhile, when the vibrating element controller drives the vibrating elements 27 at vibration frequencies lower than the minimum frequency that is audible to humans, this makes it possible to make the optical members 16 to which the vibrating elements 27 are attached vibrate without producing sound waves. A coil-type vibration element, a piezoelectric vibration element (piezoelectric ceramic) that uses a ferroelectric material such as lead zirconate titanate (PZT), or a film-type vibration element that uses an organic film such as polyvinylidene diflouride (PVDF), for example, may be used for the vibrating elements 27.

As illustrated in FIG. 1, the vibrating elements 27 are attached to the light guide plate 21 of the optical members 16. The vibrating elements 27 are fixed to the opposite surface 21c of the front and rear surfaces of the light guide plate 21 using a fixing unit (not illustrated in the figure) such as double-sided tape or an adhesive. The fixing unit is made of a low elasticity material or a hard material that does not tend to absorb the vibrations from the vibrating elements 27 and makes it possible to transmit the vibrations from the vibrating elements 27 to the light guide plate 21 with high efficiency (low loss). The light guide plate 21 to which the vibrating elements 27 are attached has a greater thickness and a higher rigidity than the other optical members 16 (the optical sheets 22 and the reflective sheet 23), thereby making it possible to more satisfactorily transmit the vibrations from the vibrating elements 27. The vibrating elements 27 are arranged in the non-effective region NEA (the non-display region NAA) that is outside of the effective region EA (the display region AA) of the light guide plate 21. Arranging the vibrating elements 27 in this position prevents the light to which optical effects are applied in the effective region EA of the light guide plate 21 from being blocked or absorbed by the vibrating elements 27, thereby preventing the optical functionality of the light guide plate 21 from being harmed as a result of attaching the vibrating elements 27 and also preventing shadows from the vibrating elements 27 from appearing in the image displayed in the display region AA of the liquid crystal panel 11. As illustrated in FIGS. 1 and 3, a plurality of the vibrating elements 27 are arranged in a line along the edge of the non-effective region NEA of the light guide plate 21 opposite to the LED 19 side edge. More specifically, of the two long side edges included in the peripheral edges of the non-effective region NEA of the light guide plate 21, the vibrating elements 27 are arranged along the long side edge that is opposite to the long side edge on the LED 19 side, with three of the vibrating elements 27 arranged intermittently in a line running in the long side direction of that long side edge. The vibrating elements 27 are arranged at the center position and at both end positions of the light guide plate 21 in that long side direction.

As illustrated in FIG. 1, the opposite surface 21c of the light guide plate 21 to which the vibrating elements 27 are attached is the surface that faces the reflective sheet 23 that is layered onto the rear side of the light guide plate 21. Therefore, the vibrating elements 27 are arranged at the same position in the Z axis direction (the thickness direction) as the reflective sheet 23 that is layered onto the rear side of the light guide plate 21. In other words, the vibrating elements 27 can be arranged in the same arrangement space used for the reflective sheet 23 that is layered onto the light guide plate 21 to which the vibrating elements 27 are attached, which is particularly advantageous in terms of making the backlight device 12 thinner.

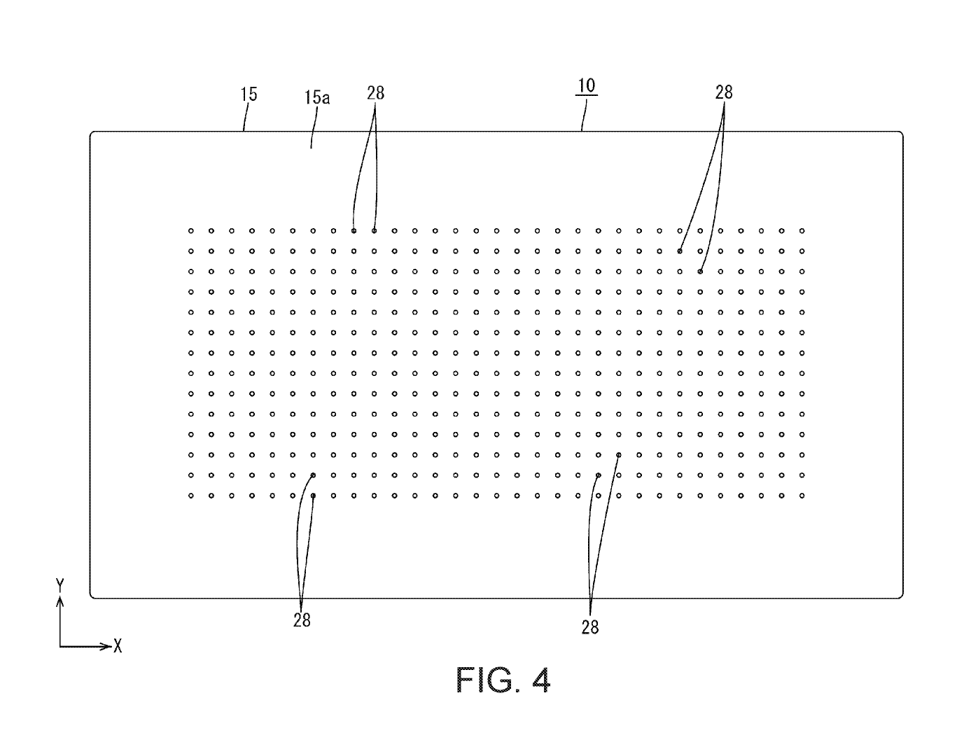

Furthermore, as illustrated in FIGS. 1 and 4, in the casing 15 that houses the liquid crystal display device 10 from the rear surface side, sound conduction openings 28 that are open to the external environment are formed in order to emit the sound produced when the vibrating elements 27 make the light guide plate 21 vibrate to the external environment. More specifically, the sound conduction openings 28 are formed going through the bottom portion 15a of the casing 15 in the thickness direction thereof and are arranged in a matrix pattern within the plane of the surface of the bottom portion 15a. The sound conduction openings 28 each have a circular hole shape when viewed in a plan view. The sound produced by the vibrations transmitted from the vibrating elements 27 to the light guide plate 21 is emitted through the sound conduction openings 28 to the external environment on the rear side of the liquid crystal display device 10 in order to be made audible to the user.

Next, the operation of the present embodiment configured as described above will be described. When the tablet-type mobile computing device TB (the liquid crystal display device 10) configured as described above is turned ON, the panel control circuit (not illustrated in the figures) and the driver 14 start to control the operation of the liquid crystal panel 11, and an LED driver circuit (not illustrated in the figures) starts to supply power to the LEDs 19 of the LED substrate 20 in order to control the operation of the LEDs 19. The optical members 16 apply optical effects to the light from the LEDs 19 as that light illuminates the liquid crystal panel 11 and is used to display prescribed images in the display region AA of the liquid crystal panel 11.

Here, the operation of the backlight device 12 will be described in more detail. As illustrated in FIG. 1, the light emitted from the LEDs 17 enters the light-receiving face 21a of the light guide plate 21, propagates throughout the interior of the light guide plate 21 by being reflected by the reflective sheet 23, for example, and then exits from the light-exiting surface 21b. The optical sheets 22 then apply the respective optical effects to the light emitted from the light-exiting surface 21b of the light guide plate 21 such that the liquid crystal panel 11 is illuminated with uniform planar light. Furthermore, when the user inputs a position (performs a touch operation) by touching the cover panel 13 according to the image displayed in the display region AA of the liquid crystal panel 11, for example, the touch panel pattern 26 of the cover panel 13 makes it possible to detect the position of that input, thereby making it possible to display an image consistent with that input information in the display region AA of the liquid crystal panel 11.

The liquid crystal display device 10 can also produce sound that is audible to the user and is consistent with the images displayed in the display region AA of the liquid crystal panel 11. As illustrated in FIG. 1, to produce sound, the vibrating element controller drives the vibrating elements 27 at a vibration frequency higher than the minimum frequency that is audible to humans, for example, in order to make the light guide plate 21 to which the vibrating elements 27 are attached vibrate accordingly. This causes the entire light guide plate 21 to vibrate at that high vibration frequency and generate sound waves from the surfaces thereof. The vibration of the light guide plate 21 is also transmitted to the other optical members 16 (the reflective sheet 23 and the optical sheets 22) that are layered onto the light guide plate 21 and therefore vibrate similarly. The sound waves generated by the surfaces of the light guide plate 21 are amplified as they reverberate throughout the space inside of the casing 15 and are then emitted from the sound conduction openings 28. This makes it possible to make sounds that are consistent with the displayed images audible to the user.

Meanwhile, the liquid crystal display device 10 can also transmit vibration to the user when the user inputs a position on the cover panel 13 according to the image displayed in the display region AA of the liquid crystal panel 11. As illustrated in FIG. 1, to transmit such vibration, the vibrating element controller drives the vibrating elements 27 at a vibration frequency lower than the minimum frequency that is audible to humans, for example, in order to make the light guide plate 21 to which the vibrating elements 27 are attached vibrate accordingly. The vibration of the light guide plate 21 is also transmitted to the other optical members 16 (reflective sheet 23 and the optical sheets 22) that are layered onto the light guide plate 21 as well as to the liquid crystal panel 11 and the cover panel 13, which all therefore vibrate in a similar manner. Thus, when the user's finger or the like touches the cover panel 13 that vibrates in unison with the light guide plate 21, the user can receive haptic feedback in the form of vibrations that are consistent with the displayed images.

As described above, the backlight device (illumination device) of the present embodiment includes the LEDs (light sources) 19, the sheet-shaped optical members 16 that apply optical effects to the light from the LEDs 19, and the vibrating elements 27 that are attached to the optical members 16 to make the optical members 16 vibrate.

In this way, the sheet-shaped optical members 16 apply optical effects to the light emitted from the LEDs 19 as that light exits. The vibrating elements 27 are attached to the optical members 16 and make the optical members 16 vibrate. Therefore, setting the vibration frequency of the vibrating elements 27 to high values makes it possible to produce sound by using the optical members 16 as a diaphragm, and setting the vibration frequency of the vibrating elements 27 to lower values than above makes it possible to transmit vibrations via the optical members 16 to the user of the backlight device 12, for example.

This configuration is advantageous in terms of making the backlight device 12 thinner because unlike in conventional configurations in which sound generated by making a piezoelectric diaphragm vibrate must pass through a sound conduction channel formed in the device before being emitted from the front side, the present configuration removes the need to allocate space for a sound conduction channel inside of the backlight device 12 and also removes the need to maintain a gap between the vibrating elements 27 and the other components (such as the chassis 18).

Furthermore, the optical members 16 are each divided into the effective region EA that applies an optical effect to the light from the LEDs 19 while emitting that light effectively and the frame-shaped non-effective region NEA that surrounds the effective region EA, and the vibrating elements 27 are attached to the non-effective region NEA of the optical members 16. This configuration prevents the light to which optical effects are applied in the effective region EA of the optical members 16 from being blocked or absorbed by the vibrating elements 27. This, in turn, prevents the optical functionality of the optical members 16 from being harmed as a result of attaching the vibrating elements 27.

Furthermore, the optical members 16 are provided in plurality and are layered together with one another, and the vibrating elements 27 are attached to the surface of the light guide plate 21 (the optical member 16 out of the plurality of optical members 16 that provides the attachment surface) that faces the reflective sheet 23 (the optical member 16 that is layered onto that optical member 16 (the light guide plate 21)). Therefore, the vibrating elements 27 that are arranged in the non-effective region NEA of the optical members 16 occupy the same position as the reflective sheet 23 (the optical member 16 that is layered onto the light guide plate 21 (the optical member 16 that provides the attachment surface)) in the thickness direction of that optical member 16 (the reflective sheet 23). In other words, the vibrating elements 27 can be arranged in the same arrangement space used for the reflective sheet 23 (the optical member 16 that is layered onto the light guide plate 21 (the optical member 16 that provides the attachment surface)), which is particularly advantageous in terms of making the backlight device 12 thinner.

Moreover, the optical members 16 include at least the light guide plate 21 that guides in the light from the LEDs 19, and the vibrating elements 27 are attached to the light guide plate 21. The light guide plate 21 has a greater thickness and a higher rigidity than the other optical members 16 (the optical sheets 22 and the reflective sheet 23), and therefore attaching the vibrating elements 27 to the light guide plate 21 makes it possible to more satisfactorily transmit the vibrations from the vibrating elements 27.

Furthermore, the liquid crystal display device (display device) 10 according to the present embodiment includes the backlight device 12 and the liquid crystal panel (display panel) 11 that is arranged on the light-emitting side of the backlight device 12 and uses the light from the backlight device 12 to display images. Configuring the liquid crystal display device 10 in this way makes it possible to make the backlight device 12 thinner, thereby making it possible to make the overall liquid crystal display device 10 thinner as well.

The liquid crystal display device 10 also includes the casing (outer case) 15 that houses the liquid crystal panel 11 and the backlight device 12, and the sound conduction openings 28 that are open to the external environment are formed in the casing 15. In this configuration, the sound produced by the vibrations transmitted from the vibrating elements 27 to the optical members 16 is emitted to the external environment through the sound conduction openings 28 formed in the casing 15 in order to be made audible to the user.

In addition, the cover panel (touch panel) 13 that has the touch panel pattern 26 for detecting the position of input from the user is arranged on the side of the liquid crystal panel 11 opposite to the backlight device 12 side. In this configuration, when the user inputs a position to the cover panel 13 according to the image displayed on the liquid crystal panel 11, the touch panel pattern 26 detects the position of that input. Vibrations from the vibrating elements 27 can then be transmitted via the optical members 16 to the cover panel 13 in order to transmit those vibrations to the user when the user inputs a position on the cover panel 13.

Moreover, the display panel is the liquid crystal panel 11 in which a liquid crystal material is sealed between the pair of substrates 11a and 11b. This type of liquid crystal display device 10 is advantageous because it can be used for a wide variety of purposes, such as in displays for mobile computing devices (including tablet computers) or the like, for example.

### Embodiment 2

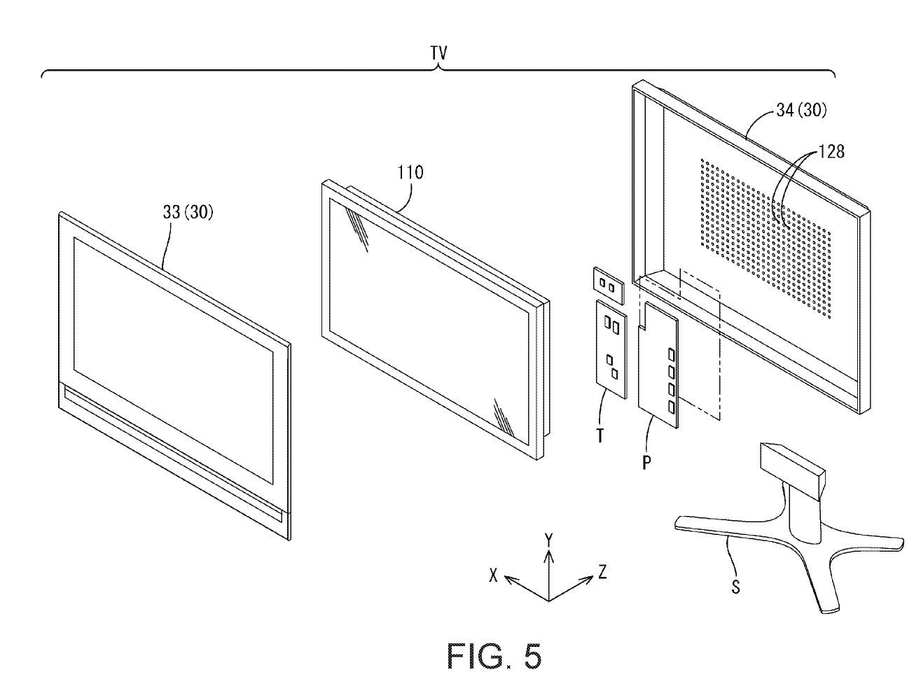

Next, Embodiment 2 of the present invention will be described with reference to FIGS. 5 to 8. In Embodiment 2, a liquid crystal display device 110 for a television receiver TV will be described. Note also that redundant descriptions of components, operations, and effects that are the same as in Embodiment 1 will be omitted here.

As illustrated in FIG. 5, the television receiver TV according to the present embodiment includes the liquid crystal display device 110, a power supply P that supplies power to the liquid crystal display device 110, a tuner (receiver) T that receives television image signals, and a stand S that supports the liquid crystal display device 110. The liquid crystal display device 110 includes a bezel 29 for supporting a liquid crystal panel 111 and a backlight device 112, the liquid crystal panel 111 and the backlight device 112 (which are layered together), and a cabinet (outer case) 30 that houses the bezel 29. The screen of the liquid crystal panel 111 of the liquid crystal display device 110 is of a size that would typically be classified as a mid- to large-sized screen, such as approximately 15 inches to 80 inches, for example. Here, the cabinet 30 serves as a replacement for the casing 15 described above in Embodiment 1 (see FIG. 1). Moreover, the liquid crystal display device 110 does not include the cover panel 13, the panel fixing tape 24, and the adhesive 25 described above in Embodiment 1 (see FIG. 1).

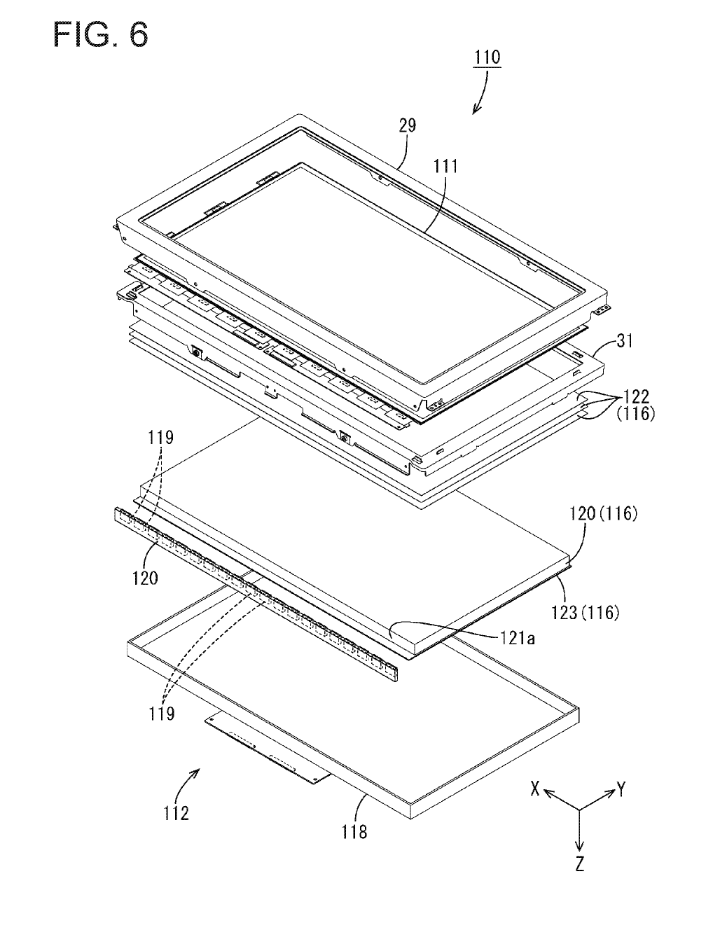

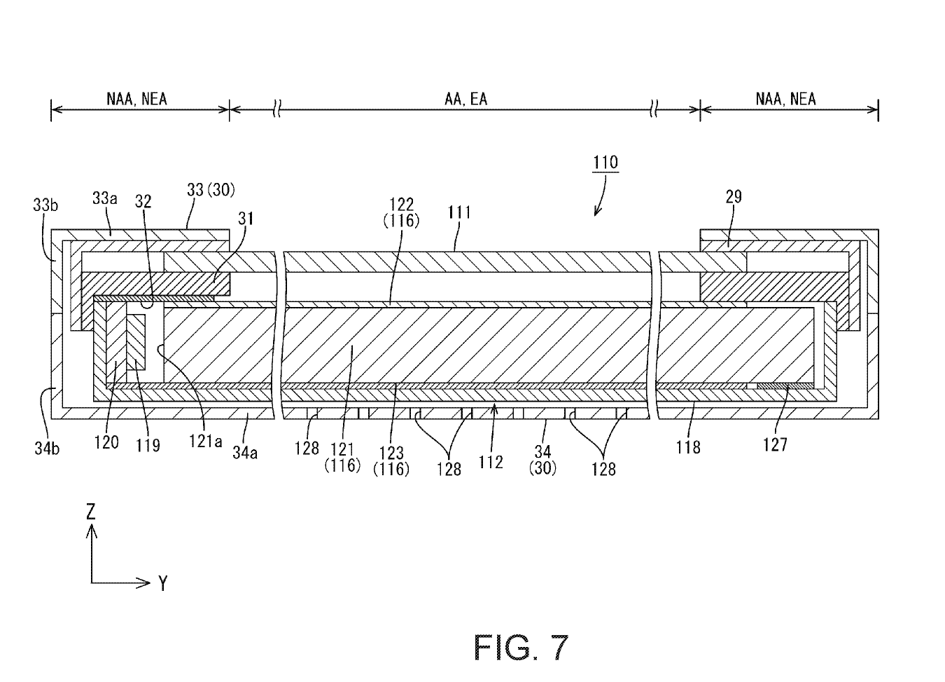

The bezel 29 is made of a metal, and as illustrated in FIG. 6, has a frame shape that follows the peripheral edges of the liquid crystal panel 111 and holds down the peripheral edges of the liquid crystal panel 111 from the front side. As illustrated in FIG. 7, the bezel 29 supports the liquid crystal panel 111 and the backlight device 112 in a sandwiched state between the bezel 29 and a chassis 118 of the backlight device 112. Meanwhile, as illustrated in FIG. 6, the backlight device 112 includes a frame-shaped frame 31 that follows the peripheral edges of optical members 116. As illustrated in FIG. 7, the frame 31 supports the optical members 116 in a sandwiched state between the frame 31 and the chassis 118 and supports the liquid crystal panel 111 in a sandwiched state between the frame 31 and the bezel 29. Moreover, in the backlight device 112, the configuration and arrangement of an LED substrate 120 are different than in Embodiment 1 as described above. More specifically, the LED substrate 120 has a plate shape with a prescribed plate thickness and is arranged with a surface thereof facing a light-receiving face 121a of a light guide plate 121, and top-emitting LEDs 119 are mounted on that surface that faces the light-receiving face 121a. Moreover, a reflective member 32 is attached to the surface of the frame 31 that faces the LED substrate 120 side, and together, the reflective member 32 and a reflective sheet 123 that is arranged on the rear side reflect light from the LEDs 119 in order to guide that light towards the light-receiving face 121a. Note that the cabinet 30 is not illustrated in FIG. 6 and that the depictions of the liquid crystal panel 111 and optical sheets 122 in FIG. 7 are simplified.

The cabinet 30 includes a first cabinet (first outer case) 33 that is arranged on the front side of the bezel 29 and a second cabinet (second outer case) that is arranged on the rear side of the backlight device 112. The first cabinet 33 and the second cabinet 34 are both made of a synthetic resin. The first cabinet 33 includes a frame-shaped restraining portion 33a that is larger than the bezel 29 in both dimensions and a tube-shaped first side portion 33b that protrudes down from the peripheral edges of the restraining portion 33a towards the rear side. The restraining portion 33a of the first cabinet 33 makes it possible to hold in the bezel 29 from the front side. The first side portion 33b of the first cabinet 33 is arranged surrounding the bezel 29 from the outer peripheral side.

The second cabinet 34 includes a bottom portion 34a that is arranged facing the rear side of the backlight device 112 and a tube-shaped second side portion 34b that protrudes up from the peripheral edges of the bottom portion 34a towards the front side. The bottom portion 34a of the second cabinet 34 is plate-shaped and larger than the backlight device 112 in both dimensions. In the bottom portion 34a, sound conduction openings 128 are formed for emitting sound produced by the light guide plate 12 (which vibrates when vibrating elements 127 are activated) to the external environment. A plurality of the sound conduction openings 128 are arranged in a matrix pattern within the plane of the surface of the bottom portion 34a. The second side portion 34b of the second cabinet 34 is arranged surrounding the backlight device 112 from the outer peripheral side, with the end faces of the protruding portions fixed to those of the first side portion 33b.

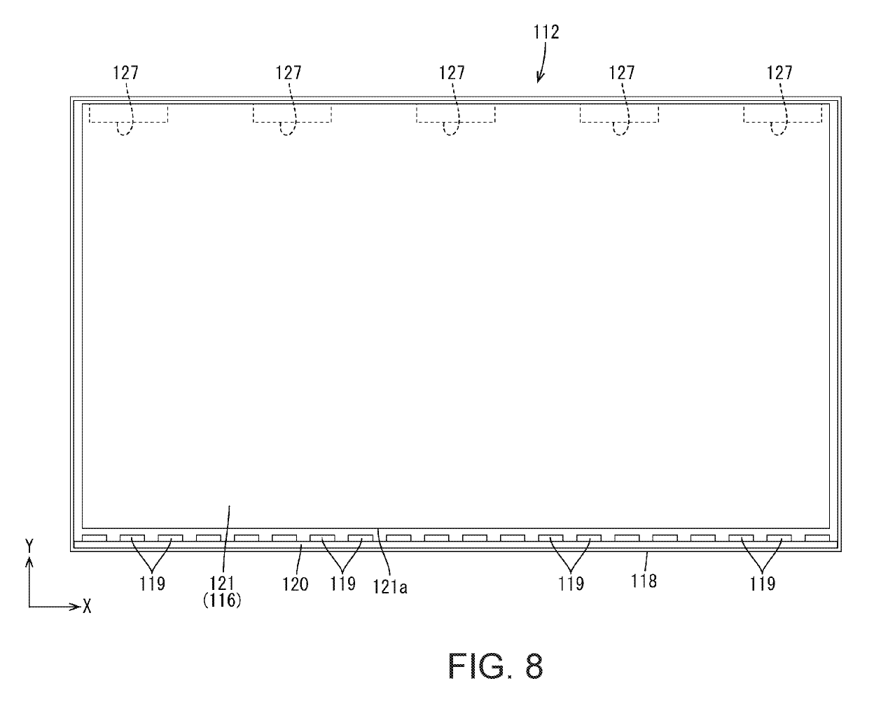

Furthermore, as illustrated in FIGS. 7 and 8, of the two long side edges included in the peripheral edges of a non-effective region NEA (non-display region NAA) that is outside of an effective region EA (display region AA) of the light guide plate 121, the vibrating elements 127 are arranged along the long side edge that is opposite to the long side edge on the LED 119 side, with five of the vibrating elements 127 arranged intermittently in a line running in the long side direction of that long side edge. Once again, configuring the liquid crystal display device 110 in this way makes it possible to make sound audible to the user by generating sound waves from the surface of the light guide plate 121 by driving the vibrating elements 127 in order to make the light guide plate 121 (the optical member 116) to which the vibrating elements 127 are attached vibrate accordingly. The sound produced by the vibrations transmitted from the vibrating elements 127 to the light guide plate 121 is emitted through the sound conduction openings 128 in the second cabinet 34 to the external environment on the rear side of the liquid crystal display device 110 in order to be made audible to the user.

### Embodiment 3

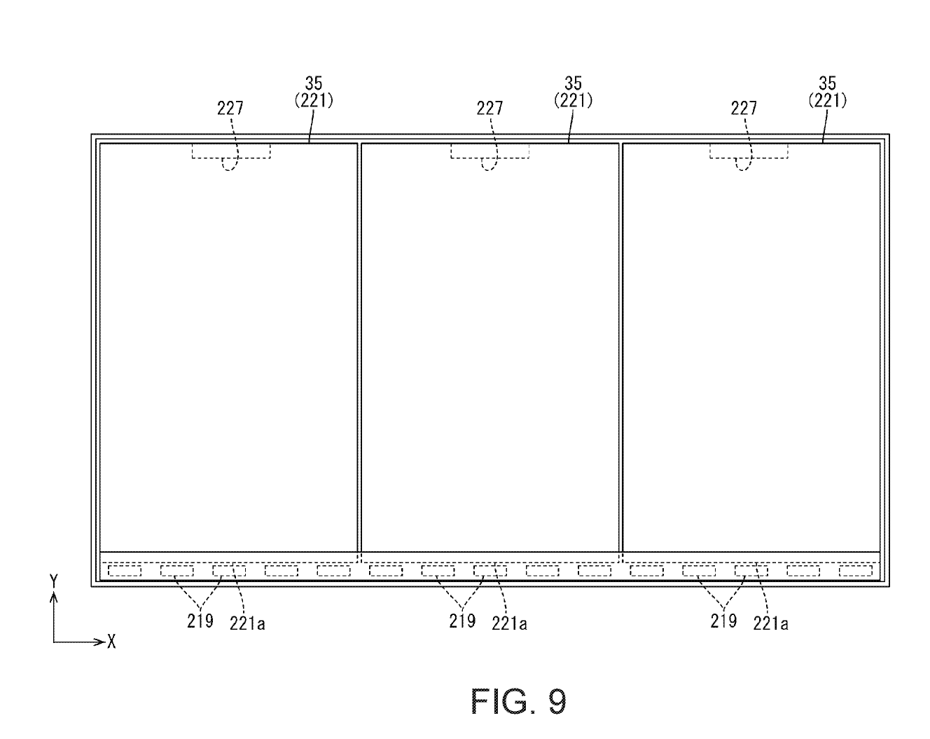

Next, Embodiment 3 of the present invention will be described with reference to FIG. 9. In Embodiment 3, the structure of a light guide plate 221 is modified in comparison with Embodiment 1 as described above. Note also that redundant descriptions of components, operations, and effects that are the same as in Embodiment 1 will be omitted here.

As illustrated in FIG. 9, the light guide plate 221 for a tablet-type mobile computing device according to the present embodiment is divided in the long side direction (the direction in which LEDs 219 are arranged) into three divided light guide plates 35. The divided light guide plates 35 each have a vertically elongated rectangular shape when viewed in a plan view, with the long side direction of the divided light guide plates 35 running parallel to the short side direction of the overall light guide plate 221 and the short side direction of the divided light guide plates 35 running parallel to the long side direction of the overall light guide plate 221. The length of the long sides of the divided light guide plates 35 is equal to the length of the short sides of the light guide plate 221, while the length of the short sides of the divided light guide plates 35 is equal to approximately ⅓ of the length of the long side of the light guide plate 221. The divided light guide plates 35 each have a light-receiving face 221a, and the same number of LEDs 219 (here, five) are arranged facing each light-receiving face such that the light from each group of the LEDs 219 enters the respective light-receiving face. Note here that optical sheets are not illustrated in FIG. 9.

Furthermore, the number of vibrating elements 227 is equal to the number of divisions in the light guide plate 221 (here, three), and one of the vibrating elements 227 is attached to each of the divided light guide plates 35. Of the two short side edges included in the peripheral edges of each of the divided light guide plates 35, the vibrating elements 227 are attached to the short side edges opposite to the short side edges on the LED 219 side. Moreover, the vibrating elements 227 are arranged in the center positions of these short side edges of the divided light guide plates 35. This makes it possible to selectively make the divided light guide plates 35 vibrate by individually controlling the operation of the vibrating elements 227 that are individually attached to the divided light guide plates 35. For example, selectively making the center divided light guide plate 35 in FIG. 9 vibrate in order to generate sound waves would result in the user hearing the resulting sound originate from the center of the screen of a liquid crystal panel (not illustrated in the figure) in the long side direction thereof. Similarly, selectively making the left or the right divided light guide plate 35 in FIG. 9 vibrate in order to generate sound waves would result in the user hearing the resulting sound originate from the left side or the right side of the screen of the liquid crystal panel in the long side direction thereof. Likewise, selectively making both the left and the right divided light guide plates 35 in FIG. 9 vibrate in order to generate sound waves would result in the user hearing the resulting sound originate from both the left side and the right side of the screen of the liquid crystal panel in the long side direction thereof. Selectively making the divided light guide plates 35 vibrate as described above makes it possible to make sound that has more excellent realistic qualities and is consistent with the images displayed on the liquid crystal panel audible to the user. Moreover, also selectively making the divided light guide plates 35 vibrate as described above when vibration is transmitted to the user when the user touches the cover panel (not illustrated in the figure) makes it possible to more effectively transmit vibrations to the user.

In the present embodiment as described above, the light guide plate 221 includes a plurality of the divided light guide plates 35, and the overall device includes a plurality of the vibrating elements 227 which are individually attached to the divided light guide plates 35. This configuration makes it possible to selectively make the divided light guide plates 35 vibrate by individually controlling the operation of the vibrating elements 227 that are individually attached to the divided light guide plates 35. This, in turn, makes it possible to transmit sound or vibration to the user from a specific one of the divided light guide plates 35.

### Embodiment 4

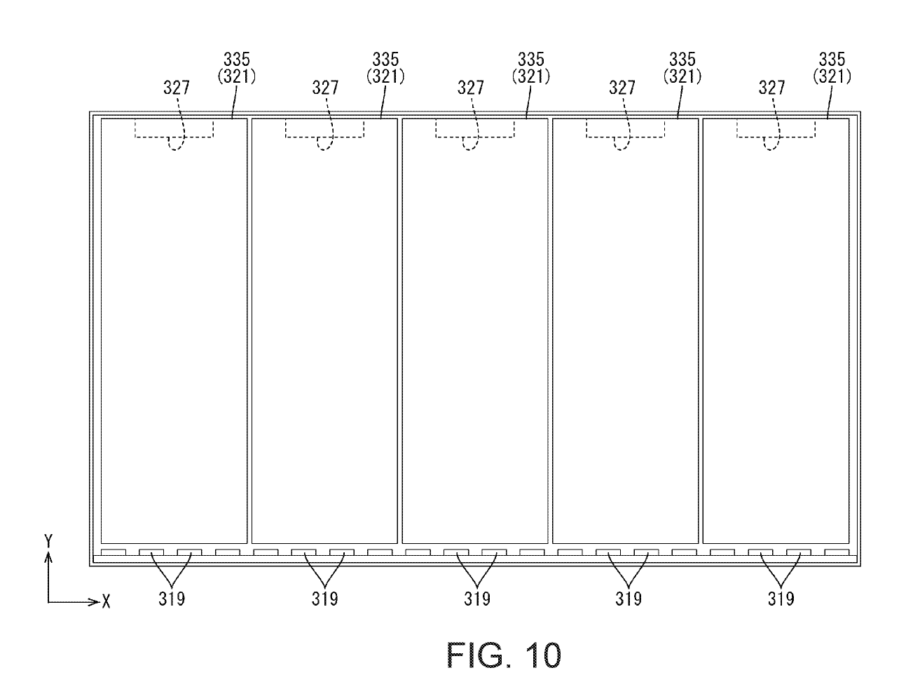

Next, Embodiment 4 of the present invention will be described with reference to FIG. 10. In Embodiment 4, the structure of a light guide plate 321 is modified in comparison with Embodiment 2 and in a manner similar to that of Embodiment 3. Note also that redundant descriptions of components, operations, and effects that are the same as in Embodiments 2 and 3 will be omitted here.

As illustrated in FIG. 10, the light guide plate 321 for a television receiver according to the present embodiment is divided in the long side direction (the direction in which LEDs 319 are arranged) into five divided light guide plates 335. The details of the configuration of the divided light guide plates 335 are otherwise the same as in Embodiment 3 as described above. The number of vibrating elements 327 is equal to the number of divisions in the light guide plate 321 (here, five), and one of the vibrating elements 327 is attached to each of the divided light guide plates 335. The positions and the like at which the vibrating elements 327 are attached to the divided light guide plates 335 are similar to in Embodiment 3 as described above. This makes it possible to selectively make the divided light guide plates 335 vibrate by individually controlling the operation of the vibrating elements 327 that are individually attached to the divided light guide plates 335. This, in turn, makes it possible to make sound that has more excellent realistic qualities and is consistent with the television images displayed on a liquid crystal panel (not illustrated in the figure) audible to the user.

### Embodiment 5

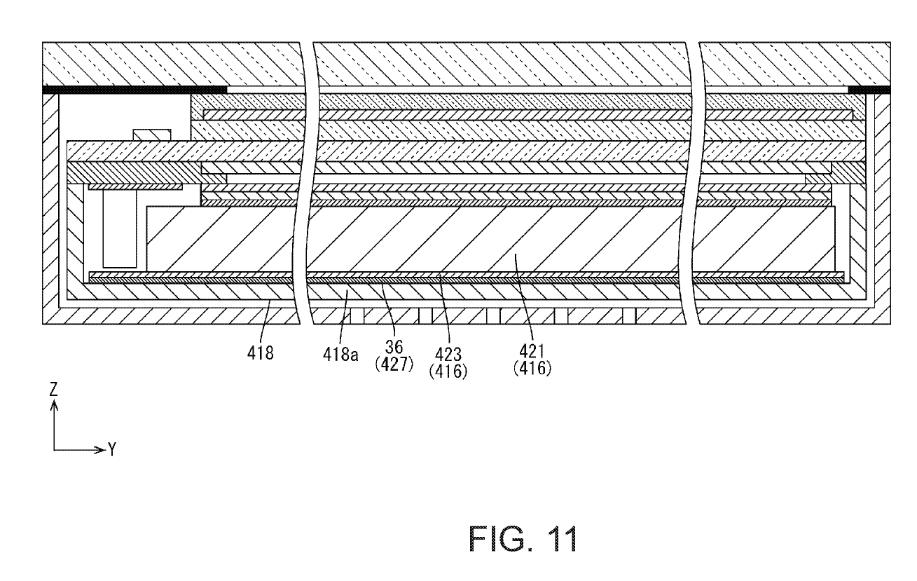

Next, Embodiment 5 of the present invention will be described with reference to FIG. 11. In Embodiment 5, the configuration of a vibrating element 427 is modified in comparison with Embodiment 1 as described above. Note also that redundant descriptions of components, operations, and effects that are the same as in Embodiment 1 will be omitted here.

As illustrated in FIG. 11, the vibrating element 427 according to the present embodiment is a film-shaped film-type vibration element 36. This film-type vibration element 36 is arranged sandwiched between a reflective sheet 423 and a bottom portion 418a of a chassis 418, and when viewed in a plan view, the size of the film-type vibration element 36 is greater than the size of a light guide plate 421 in both dimensions and approximately equal to the size of the reflective sheet 423. The film-type vibration element 36 is attached in surface contact with substantially the entire rear surface of the reflective sheet 423. Therefore, when the film-type vibration element 36 is activated, the entire reflective sheet 423 and the entire light guide plate 421 vibrate.

In the present embodiment as described above, the vibrating element 427 is constituted by the film-shaped film-type vibration element 36 and is attached in surface contact with the surface of the reflective sheet 423 (an optical member 416). This makes it possible to transmit vibrations from the film-type vibration element 36 to the entire surface of the reflective sheet 423 (optical member 416) that is arranged in surface contact with the film-type vibration element 36.

### Embodiment 6

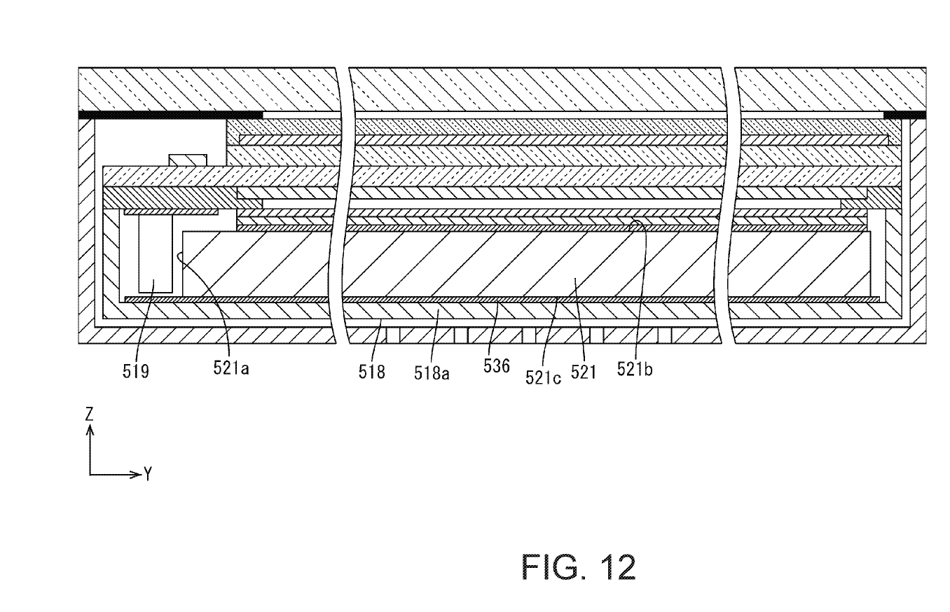

Next, Embodiment 6 of the present invention will be described with reference to FIG. 12. In Embodiment 6, the configuration of a film-type vibration element 536 is modified in comparison with Embodiment 5 as described above. Note also that redundant descriptions of components, operations, and effects that are the same as in Embodiment 5 will be omitted here.

As illustrated in FIG. 12, in the film-type vibration element 536 according to the present embodiment, a reflective treatment for making the surface of the element reflect light is applied thereto. More specifically, a white paint with excellent light reflection properties is applied to the surface of the film-type vibration element 536. Furthermore, the film-type vibration element 536 is arranged replacing the reflective sheet 423 described above in Embodiment 5 (see FIG. 11). In other words, the film-type vibration element 536 is arranged sandwiched between a light guide plate 521 and a bottom portion 518a of a chassis 518, and when viewed in a plan view, the size of the film-type vibration element 536 is greater than the size of the light guide plate 521 in both dimensions. The film-type vibration element 536 is attached in surface contact with substantially an entire opposite surface 521c of the light guide plate 521. Therefore, when the film-type vibration element 536 is activated, the entire opposite surface 521c of the light guide plate 521 vibrates. Meanwhile, when light from LEDs 519 enters a light-receiving face 521a of the light guide plate 521, as that light that enters propagates throughout the interior of the light guide plate 521, that light is reflected with high efficiency off of the surface of the film-type vibration element 536 and is thus directed upwards towards a light-exiting surface 521b side. In this way, the film-type vibration element 536 exhibits both a vibration feature as well as a reflection feature for reflecting the light propagating throughout the interior of the light guide plate 521. This makes it possible to remove the reflective sheet 423 described above in Embodiment 5, which reduces the number of component parts and the number of assembly steps required and is therefore advantageous in terms of reducing production costs.

In the film-type vibration element 536 according to the present embodiment as described above, a reflective treatment for making the surface of the element reflect light is applied thereto. Therefore, light from the LEDs 519 reflects off of the surface of the film-type vibration element 536, thereby making it possible to emit that light more efficiently. This reduces the number of component parts and the number of assembly steps required in comparison with a configuration that includes a reflective sheet separate from the film-type vibration element 536 as an optical member for reflecting light and is therefore advantageous in terms of reducing production costs.

### Embodiment 7

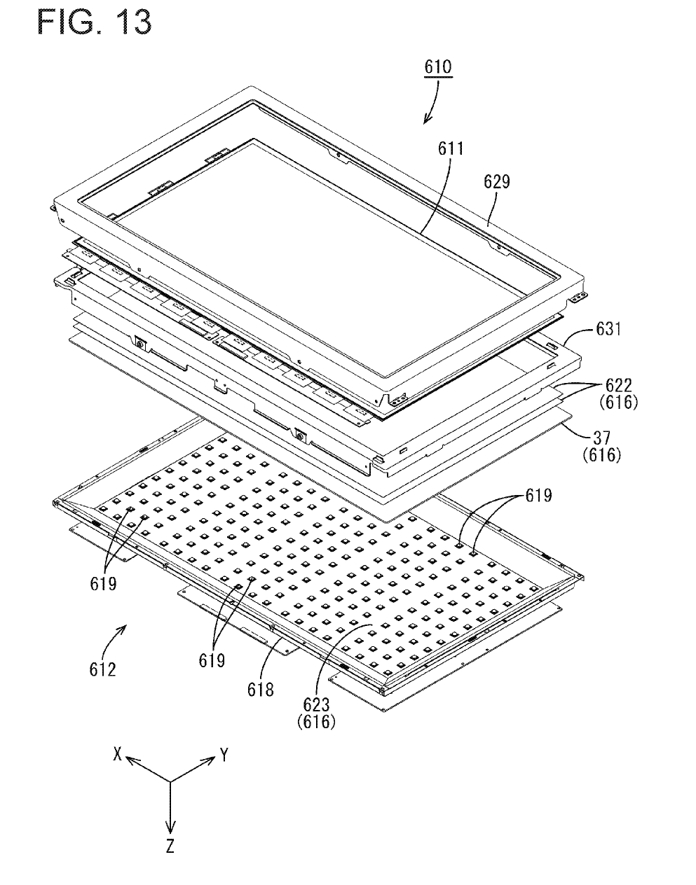

Next, Embodiment 7 of the present invention will be described with reference to FIGS. 13 to 15. In Embodiment 7, the structure of a backlight device 612 is modified in comparison with Embodiment 2 to be a direct-lit backlight device. Note also that redundant descriptions of components, operations, and effects that are the same as in Embodiment 2 will be omitted here.

As illustrated in FIG. 13, a liquid crystal display device 610 for a television receiver according to the present embodiment includes a liquid crystal panel 611 and the direct-lit backlight device 612, which are held together by a bezel 629 or the like. Next, the configuration of the direct-lit backlight device 612 will be described.

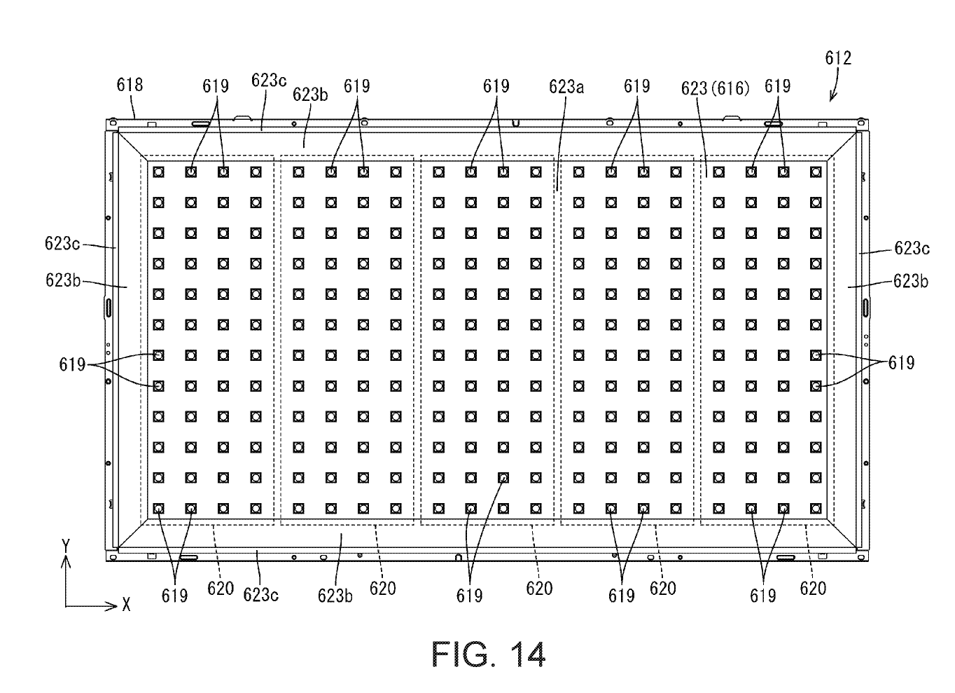

As illustrated in FIG. 14, the backlight device 612 includes a substantially box-shaped chassis 618 that is open towards the front side, a diffusion plate 37 and an optical sheet 622 (which are optical members 616) that are arranged covering the opening of the chassis 618, and a frame 631 that is arranged running along the outer edges of the chassis 618 and supports the outer edges of the diffusion plate 37 and the optical sheet 622 in a sandwiched state between the chassis 618 and the frame 631. The backlight device 612 also includes, within the chassis 618, LEDs 619 that are arranged facing the diffusion plate 37 and the optical sheet 622 (and the liquid crystal panel 611) at positions directly therebeneath, LED substrates 620 on which the LEDs 619 are mounted, and a reflective sheet 623 (an optical member 616) that reflects light within the chassis 618 in order to direct that light towards the diffusion plate 37 and optical sheet 622 side. The backlight device 612 according to the present embodiment is direct-lit and therefore does not include the light guide plate 121 used in the edge-lit backlight device 112 described in Embodiment 2. Moreover, the configuration of the frame 631 is the same as in Embodiment 1 except in that no reflective member 32 is included, and therefore a detailed description will be omitted here. Next, each component of the backlight device 612 will be described in detail.

The chassis 618 is made of a metal, and as illustrated in FIGS. 13 and 14, has a shallow and substantially box-shaped shape overall that is open towards the front side and includes a bottom plate 618a that has a horizontally elongated rectangular shape similar to the liquid crystal panel 611, side plates 618b that respectively extend up from the outer edges on each side of the bottom plate 618a towards the front side, and supporting plates 38 that extend outwards from the extending ends of the side plates 618b. The frame 631 as well as the diffusion plate 37 and the optical sheet 622 (described below) can be rested on the supporting plates 38 of the chassis 618 from the front side. Moreover, the frame 631 is fastened to the supporting plates 38 using screws.

As illustrated in FIGS. 13 and 14, the diffusion plate 37 is formed by dispersing a large number of diffusive particles within a substantially transparent base material made of a resin and having a greater thickness than the optical sheet 622, and the diffusion plate 37 diffuses light that passes therethrough. The diffusion plate 37 is arranged with the rear surface thereof facing light-emitting surfaces 619a of the LEDs 619 and with a prescribed gap maintained therebetween. As illustrated in FIG. 13, the optical sheet 622 is sheet-shaped and thinner than the diffusion plate 37 and includes two sheets that are layered together. Note that the depiction of the optical sheet 622 in FIG. 14 is simplified.

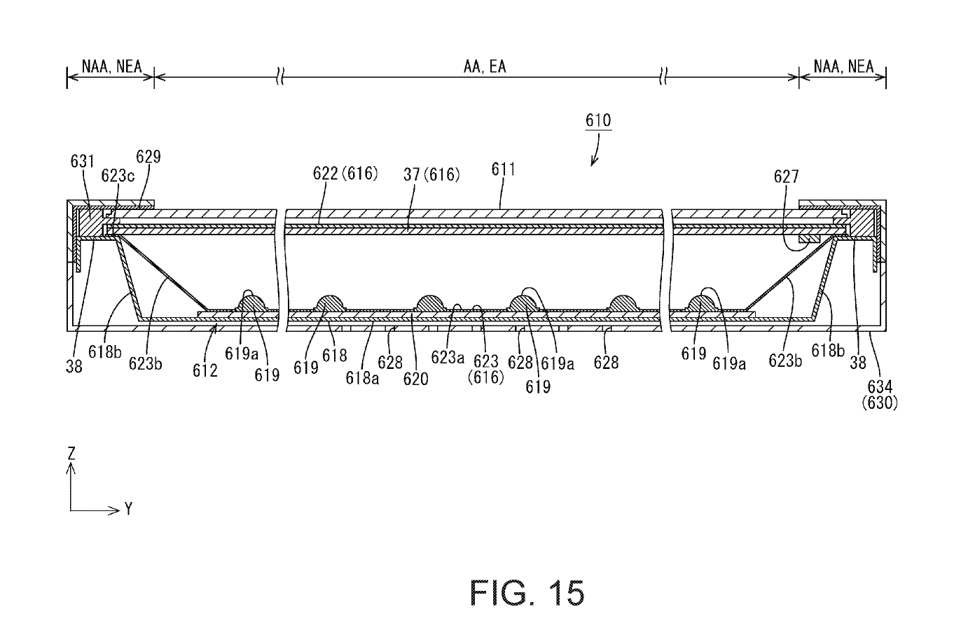

Next, the LED substrates 620 on which the LEDs 619 are mounted will be described. As illustrated in FIGS. 14 and 15, the LED substrates 620 have a vertically elongated rectangular shape when viewed in a plan view and are housed inside of the chassis 618, with the long side direction parallel to the Y axis direction and the short side direction parallel to the X axis direction. Of the surfaces of the base material of the LED substrates 620, the LEDs 619 are surface-mounted on the surfaces that face the front side (that is, on the surfaces that face the diffusion plate 37 and the optical sheet 622 side). A plurality of the LED substrates 620 are arranged in a line running in the X axis direction inside of the chassis 618, with the long side directions and the short side directions of the substrates respectively aligned with one another. More specifically, five of the LED substrates 620 are arranged in a line running in the X axis direction inside of the chassis 618, and the direction in which the substrates are arranged is parallel to the X axis direction.

As illustrated in FIGS. 14 and 15, a plurality of the LEDs 619 are arranged into rows and columns (a matrix pattern, a grid pattern) within the planes of the mounting surfaces of the LED substrates 620 and are electrically connected to one another by a wiring pattern. More specifically, on the mounting surfaces of the LED substrates 620, the LEDs 619 are arranged into matrix patterns that respectively include rows of four of the LEDs 619 running in the short side direction and columns of 12 of the LEDs 619 running in the long side direction. The LEDs 619 are arranged at a substantially fixed pitch on the LED substrates 620. More specifically, the LEDs 619 are arranged at a substantially equal pitch in both the X axis direction (the row direction) and the Y axis direction (the column direction). The LEDs 619 are top-emitting LEDs in which the faces that are on the side opposite to the light-emitting surfaces 619a are mounted on the LED substrates 620.

As illustrated in FIGS. 14 and 15, the reflective sheet 623 has a size that covers substantially the entire inner surface of the chassis 618; that is, a size that completely covers all of the LED substrates 620 that are arranged on and parallel to the bottom plate 618a. The reflective sheet 623 makes it possible to reflect the light within the chassis 618 towards the diffusion plate 37 and optical sheet 622 side. The reflective sheet 623 includes a bottom portion 623a that extends along the bottom plate 618a of the chassis 618 and has a size that covers the majority of the bottom plate 618a, four upright portions 623b that extend up from the outer edges of the bottom portion 623a towards the front side at an angle relative to the bottom portion 623a, and extending portions 623c that extend outwards from the outer edges of the upright portions 623b and rest on the supporting plates 38 of the chassis 618. The bottom portion 623a of the reflective sheet 623 is layered onto the front surfaces of the LED substrates 620 (that is, on the front sides of the surfaces on which the LEDs 619 are mounted). Moreover, holes that allow the LEDs 619 to be inserted therethrough are formed in the reflective sheet 623 at the corresponding positions.

Furthermore, as illustrated in FIG. 15, vibrating elements 627 are attached to the diffusion plate 37 of the optical members 616. The vibrating elements 627 are attached to the rear surface of the diffusion plate 37. The vibrating elements 627 are arranged along one of the long side edges included in the peripheral edges of a non-effective region NEA (non-display region NAA) that is outside of an effective region EA (display region AA) of the diffusion plate 37, with five of the vibrating elements 627 arranged intermittently in a line running in the long side direction of that long side edge. Once again, configuring the liquid crystal display device 610 in this way makes it possible to make sound audible to the user by generating sound waves from the surface of the diffusion plate 37 by driving the vibrating elements 627 in order to make the diffusion plate 37 (the optical member 616) to which the vibrating elements 627 are attached vibrate accordingly. Furthermore, in a second cabinet 634 of a cabinet 630, sound conduction openings 628 are formed for emitting sound produced by the diffusion plate 37 when the vibrating elements 627 are activated to the external environment.

In the present embodiment as described above, the optical members 616 include the diffusion plate 37 that diffuses the light from the LEDs 619, while the LEDs 619 have light-emitting surfaces 619 for emitting light and are arranged with those light-emitting surfaces 619a facing the surface of the diffusion plate 37, and the vibrating elements 627 are attached to the diffusion plate 37. In this configuration, the light emitted from the light-emitting surfaces 619a of the LEDs 619 travels towards and enters the surface of the diffusion plate 37 that is arranged facing the light-emitting surfaces 619a, and this light is diffused by the diffusion plate 37 as it exits and travels towards the liquid crystal panel 611. This reduces irregularities in brightness in the light that illuminates the liquid crystal panel 611 and also results in a higher light utilization efficiency than in an edge-lit backlight device. Furthermore, attaching the vibrating elements 627 to the diffusion plate 37 makes it possible to transmit vibrations through the diffusion plate 37 to the user of the backlight device 612.

### Embodiment 8

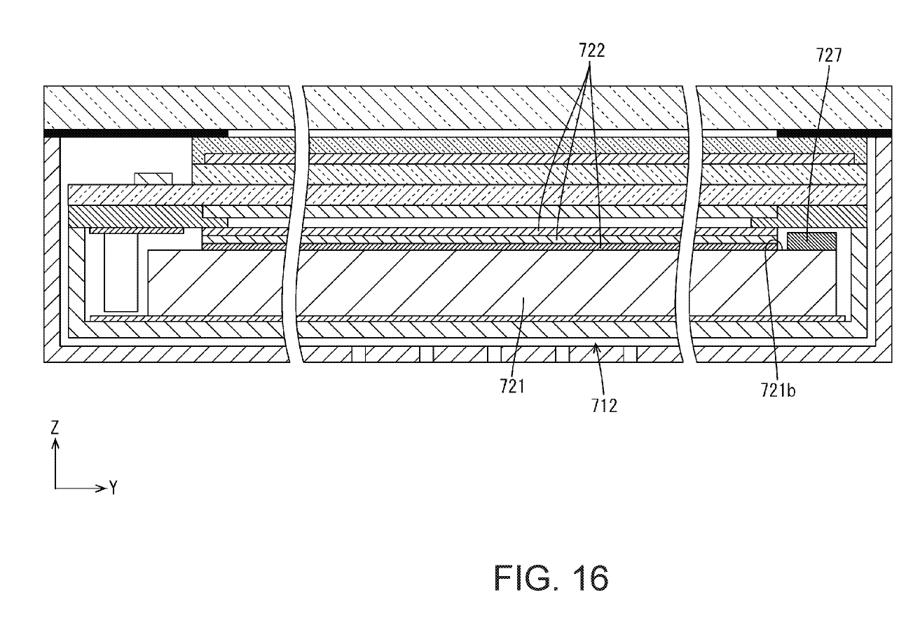

Next, Embodiment 8 of the present invention will be described with reference to FIG. 16. In Embodiment 8, the configuration of a vibrating element 727 is modified in comparison with Embodiment 1 as described above. Note also that redundant descriptions of components, operations, and effects that are the same as in Embodiment 1 will be omitted here.

As illustrated in FIG. 16, of the front and rear surfaces of a light guide plate 721, the vibrating element 727 according to the present embodiment is attached to a light-exiting surface 721b on the front side. The light-exiting surface 721b of the light guide plate 721 to which the vibrating element 727 is attached is the surface that faces optical sheets 722 that are layered onto the front side of the light guide plate 721. Therefore, the vibrating element 727 is arranged at the same position in the Z axis direction (the thickness direction) as the optical sheets 722 that are layered onto the front side of the light guide plate 721. In other words, the vibrating element 727 can be arranged in the same arrangement space used for the optical sheets 722 that are layered onto the light guide plate 721 to which the vibrating element 727 is attached, which is particularly advantageous in terms of making a backlight device 712 thinner. Furthermore, the optical sheets 722 include three sheets that are layered together on the light guide plate 721, which makes it possible to arrange the vibrating element 727 using an arrangement space equal in thickness to the three optical sheets 722 and is particularly advantageous in consideration of the fact that the thickness of the vibrating element 727 tends to be large.

### Embodiment 9

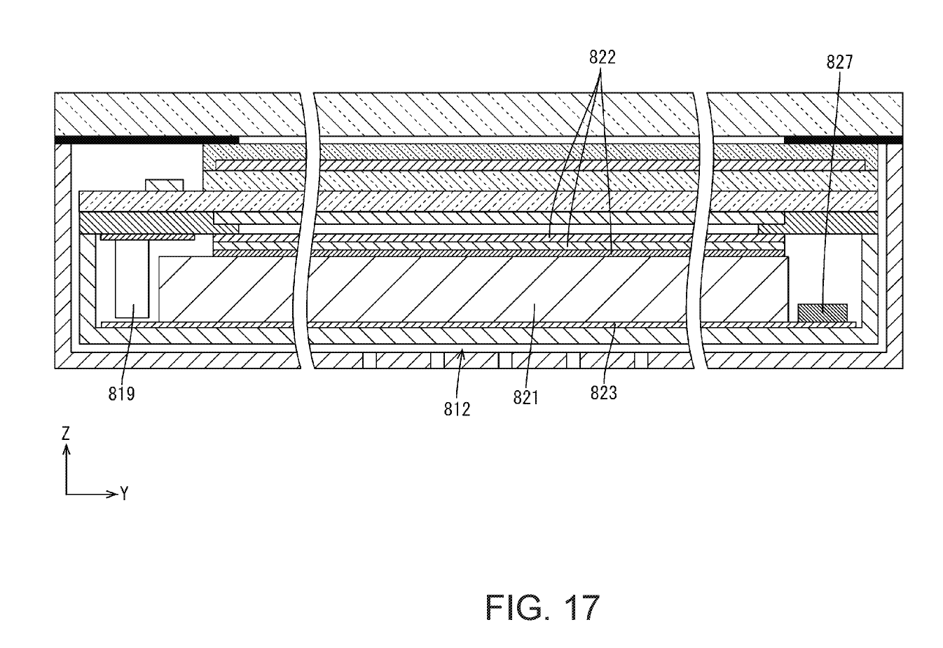

Next, Embodiment 9 of the present invention will be described with reference to FIG. 17. In Embodiment 9, the configuration of a vibrating element 827 is modified in comparison with Embodiment 1 as described above. Note also that redundant descriptions of components, operations, and effects that are the same as in Embodiment 1 will be omitted here.

As illustrated in FIG. 17, the vibrating element 827 according to the present embodiment is attached to a reflective sheet 823. More specifically, the vibrating element 827 is attached to the front surface of a portion of the reflective sheet 823 that extends outwards further than a light guide plate 821. Even more specifically, the reflective sheet 823 is formed extending further outwards in the Y axis direction than both long side end faces of the light guide plate 821, and of these two extending portions, the vibrating element 827 is attached to the extending portion on the side opposite to an LED 819 side. The front surface of the reflective sheet 823 to which the vibrating element 827 is attached is the surface that faces the light guide plate 821 that is layered onto the front side of the reflective sheet 823. Therefore, the vibrating element 827 is arranged at the same position in the Z axis direction (the thickness direction) as the light guide plate 821 that is layered onto the front side of the reflective sheet 823. In other words, the vibrating element 827 can be arranged in the same arrangement space used for the light guide plate 821 that is layered onto the reflective sheet 823 to which the vibrating element 827 is attached, which is particularly advantageous in terms of making a backlight device 812 thinner. Furthermore, the light guide plate 821 has a greater thickness than optical sheets 822 and the reflective sheet 823, which makes it possible to arrange the vibrating element 827 using an arrangement space equal in thickness to the relatively thick light guide plate 821 and is particularly advantageous in consideration of the fact that the thickness of the vibrating element 827 tends to be large.

### Embodiment 10

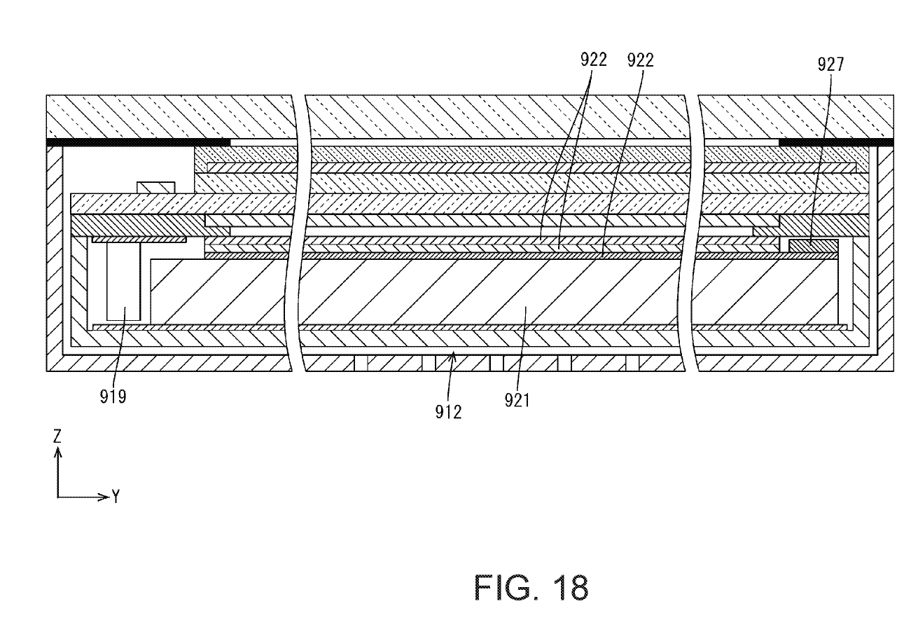

Next, Embodiment 10 of the present invention will be described with reference to FIG. 18. In Embodiment 10, the configuration of a vibrating element 927 is modified in comparison with Embodiment 1 as described above. Note also that redundant descriptions of components, operations, and effects that are the same as in Embodiment 1 will be omitted here.

As illustrated in FIG. 18, the vibrating element 927 according to the present embodiment is attached to an optical sheet 922. More specifically, of three optical sheets 922, the optical sheet 922 nearest to a light guide plate 921 has a long side edge (on the side opposite to an LED 919 side) that extends out to a position flush with the corresponding edge of the light guide plate 921, and the vibrating element 927 is attached to the front surface of that extending portion. The front surface of the optical sheet 922 to which the vibrating element 927 is attached is the surface that faces the other optical sheets 922 that are layered onto the front side of that former optical sheet 922. Therefore, the vibrating element 927 is arranged at the same position in the Z axis direction (the thickness direction) as the other optical sheets 922 that are layered onto the front side of the optical sheet 922 to which the vibrating element 927 is attached. In other words, the vibrating element 927 can be arranged in the same arrangement space used for the two optical sheets 922 that are layered onto the optical sheet 922 to which the vibrating element 927 is attached, which is particularly advantageous in terms of making a backlight device 912 thinner.

### Other Embodiments

The present invention is not limited to the embodiments as presented in the descriptions and figures above, and embodiments such as the following are also included in the technical scope of the present invention.

(1) In the embodiments described above (except for Embodiment 7), the vibrating elements are attached to the peripheral edge of the optical member on the side opposite to LED side in a one-side edge-lit backlight device. However, the vibrating elements may also be attached to the peripheral edge of the optical member on the LED side. Alternatively, the vibrating elements may be attached to the peripheral edges of the optical member that are adjacent to the edge on the LED side (that is, the short side edges).

(2) In the embodiments described above, the vibrating elements are attached to just one edge of the peripheral edges of the optical member. However, the vibrating elements may also be attached to several of the edges of the peripheral edges of the optical member.

(3) In the embodiments described above, the vibrating elements are attached to the long side edge of a rectangular optical member. However, the vibrating elements may alternatively be attached to the short side edges of the rectangular optical member.

(4) The specific number, arrangement, and the like of the vibrating elements that are attached to the optical member may be changed as appropriate to achieve configurations other than those in the embodiments described above.

(5) In the embodiments described above, the sound conduction openings were formed in the bottom portion of the casing or in the bottom portion of the cabinet. However, the sound conduction openings may alternatively be formed in the sidewalls of the casing or in the side portions of the cabinet. Moreover, the sound conduction openings may be formed in both the bottom portion and the sidewalls of the casing or in both the bottom portion and the side portions of the cabinet.

(6) In the embodiments described above (except for Embodiments 2, 4, and 7), the touch panel pattern is formed on the cover panel. However, the present invention can also be applied to configurations in which the touch panel pattern is formed on the array substrate or the CF substrate of the liquid crystal panel.

(7) In Embodiments 3 and 4 as described above, the light guide plate included three or five divided light guide plates. However, the specific number of divisions in the light guide plate (that is, the number of divided light guide plates) may be modified as appropriate.

(8) In the embodiments described above (except for Embodiment 7), a one-side edge-lit backlight device was used as an example. However, the present invention can also be applied to two-side edge-lit backlight devices.

(9) The cover panel (touch panel) described in embodiments such as Embodiment 1 can also be used in the television receivers described in Embodiments 2, 4, and 7.

(10) The film-type vibration element described in Embodiments 5 and 6 can also be used in the television receivers described in Embodiments 2 and 4.

(11) The arrangement of the vibrating elements described in Embodiments 8 to 10 can also be used in the television receivers described in Embodiments 2 and 4.

(12) In the embodiments described above (except for Embodiments 2, 4, and 7), tempered glass to which a chemical strengthening process was applied was used for the cover panel. However, tempered glass to which an air cooling strengthening process (physical strengthening process) is applied can also be used.

(13) In the embodiments described above (except for Embodiments 2, 4, and 7), tempered glass was used for the cover panel. However, materials other than tempered glass such as standard glass (non-tempered glass) or a synthetic resin may also be used.

(14) In the embodiments described above (except for Embodiments 2, 4, and 7), the cover panel can also be removed entirely.

(15) In the embodiments described above, a liquid crystal panel with a horizontally elongated rectangular display region was used. However, a liquid crystal panel with a vertically elongated rectangular display region or a liquid crystal panel with a square display region may also be used.

(16) In the embodiments described above, the liquid crystal panel includes color filters having colored portions of three colors: R, G, and B. However, colored portions of or four or more colors may alternatively be used.

(17) In the embodiments described above, LEDs were used at the light sources for the backlight device. However, other types of light sources such as organic electroluminescent light sources may alternatively be used.

(18) In the embodiments described above, transmissive liquid crystal display devices were used. However, the present invention may also be applied to other types of devices such as semi-transmissive liquid crystal display devices.

(19) In the embodiments described above, TFTs were used as the switching elements for the liquid crystal display devices. However, the present invention may also be applied to liquid crystal display devices in which switching elements other than TFTs (such as thin-film diodes (TFD)) are used. Moreover, the present invention may also be applied to liquid crystal display devices other than those that display color such as liquid crystal display device that display only black and white.

(20) In the embodiments described above (except for Embodiments 2, 4, and 7), a liquid crystal display device for a tablet-type mobile computing device was used. However, the present invention may also be applied to liquid crystal display devices for smartphones with voice calling features, feature phones, phablet devices having a larger screen size, and the like.

(21) In Embodiments 2, 4, and 7 as described above, liquid crystal display devices for television receivers that include a tuner were used as an example. However, the present invention may also be applied to display devices that do not include a tuner. More specifically, the present invention may be applied to liquid crystal display devices used in digital signage and electronic whiteboards that have screen sizes larger than television receivers.

### DESCRIPTION OF REFERENCE CHARACTERS

10, 110, 610 liquid crystal display device (display device)
11, 111, 611 liquid crystal panel (display panel)
11a CF substrate (substrate)
11b array substrate (substrate)
12, 112, 612, 712, 812, 912 backlight device (illumination device)
13 cover panel (touch panel)
15 casing (outer case)
16, 116, 416, 616 optical member
19, 119, 219, 319, 519, 619, 819, 919 LED (light source)
19a, 619a light-emitting surface
21, 121, 221, 321, 421, 521, 721, 821, 921 light guide plate (optical member)
22, 122, 622, 722, 822, 922 optical sheet (optical member)
23, 123, 423, 623, 823 optical sheet (optical member)
26 touch panel pattern
27, 127, 227, 327, 427, 627, 727, 828, 927 vibrating element
28, 128, 628 sound conduction opening
30, 630 cabinet (outer case)
35, 335 divided light guide plate
36, 536 film-type vibration element
37 diffusion plate
EA effective region
NEA non-effective region

1. An illumination device, comprising:
a light source;
an optical member that is sheet-shaped and applies an optical effect to light from the light source; and
a vibrating element attached to the optical member for causing the optical member to vibrate.

2. The illumination device according to claim 1,
wherein the vibrating element is attached to a periphery of the optical member.

3. The illumination device according to claim 2, further comprising:
additional optical members layered together and attached to an area on a surface of the optical member
wherein the vibrating element is attached to another area on said surface of the optical member.

4. The illumination device according to claim 1,
wherein the optical member includes at least a light guide plate for guiding light from the light source, and
wherein the vibrating element is attached to the light guide plate.

5. The illumination device according to claim 4,
wherein the light guide plate comprises a plurality of divided light guide plates, and
wherein the vibrating element is provided in a plurality with one attaching to each of the plurality of divided light guide plates.

6. The illumination device according to claim 1,
wherein the optical member includes a diffusion plate that diffuses light from the light source, whereas the light source has a light-emitting surface for emitting light and is arranged with that light-emitting surface opposing a surface of the diffusion plate, and
wherein the vibrating element is attached to the diffusion plate.

7. The illumination device according to claim 1, wherein the vibrating element is a film-shaped film-type vibrating element and makes surface-to-surface contact with a surface of the optical member.

8. The illumination device according to claim 7, wherein the film-type vibration element has had a reflective treatment for making a surface thereof reflect light.

9. A display device, comprising:
the illumination device according to claim 1; and
a display panel that is arranged on a light-emitting side of the illumination device and that uses light from the illumination device to display an image.

10. The display device according to claim 9, further comprising:
an outer case housing the display panel and the illumination device,
wherein sound conduction openings that are open to outside are formed in the outer case.

11. The display device according to claim 9, further comprising:
a touch panel disposed on a side of the display panel opposite to the illumination device and having a touch panel pattern for detecting a position of input from a user.

12. The display device according to claim 9, wherein the display panel is a liquid crystal panel in which a liquid crystal material is sealed between a pair of substrates.
